(19) United States
(12) Patent Application Publication
(10) Pub. No.: US 2026/0194853 A1
(43) Pub. Date: Jul. 9, 2026

(54) CARTRIDGE AND IMAGE FORMING APPARATUS

(71) Applicant: CANON KABUSHIKI KAISHA, Tokyo (JP)

(72) Inventor: KENJI MATSUDA, Shizuoka (JP)

(21) Appl. No.: 19/407,620

(22) Filed: Dec. 3, 2025

(30) Foreign Application Priority Data
Dec. 5, 2024 (JP) 2024-212268

(51) Int. Cl. G03G 21/00; G03G 15/02; G03G 21/16; G03G 21/18

(52) U.S. Cl. CPC G03G 21/0058; G03G 15/0291; G03G 21/0047; G03G 21/0082; G03G 21/1633; G03G 21/1652; G03G 21/1814; G03G 21/1817; G03G 2221/0042; G03G 2221/1606; G03G 2221/1627; G03G 2221/163

(57) ABSTRACT

A cartridge includes (i) a photoconductor-drum unit including a photoconductor drum configured to rotate about a first rotation axis, a charging wire configured to charge a surface of the photoconductor drum, and a cleaning member configured to clean the surface of the photoconductor drum, the photoconductor-drum unit having an end face on one-end side in a direction of the first rotation axis, the end face being provided with a wire electrode electrically connected to the charging wire, and a cleaning electrode electrically connected to the cleaning member; and (ii) a development unit detachably attached to the photoconductor-drum unit and including a developing roller configured to rotate about a second rotation axis. When viewed in the direction, the wire electrode and the cleaning electrode are located on opposite sides with respect to a virtual straight line passing through the first rotation axis and the second rotation axis.

### BACKGROUND

### Field of the Technology

The present disclosure relates to a cartridge to be included in an image forming apparatus and to an image-forming apparatus configured to form an image on a recording material.

### Description of the Related Art

A drum cartridge disclosed in Japanese Patent Laid-Open No. 2015-194572 includes a photoconductor drum, a scorotron charging device, and a cleaning unit. The drum cartridge includes two electrodes electrically connected to a charging wire and a grid that are included in the charging device, and two electrodes electrically connected to a primary roller and a secondary roller that are included in the cleaning unit.

### SUMMARY

According to an aspect of the present disclosure, there is provided a

cartridge including (i) a photoconductor-drum unit including a photoconductor drum configured to rotate about a first rotation axis, a charging wire configured to charge a surface of the photoconductor drum, and a cleaning member configured to clean the surface of the photoconductor drum, the photoconductor-drum unit having an end face on one-end side in a direction of the first rotation axis, the end face being provided with a wire electrode electrically connected to the charging wire, and a cleaning electrode electrically connected to the cleaning member; and (ii) a development unit detachably attached to the photoconductor-drum unit and including a developing roller configured to rotate about a second rotation axis and to supply developer to the photoconductor drum. When viewed in the direction of the first rotation axis, the wire electrode and the cleaning electrode are located on opposite sides with respect to a virtual straight line passing through the first rotation axis and the second rotation axis.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view of an image forming apparatus according to an embodiment.

FIG. 2A is a perspective view of an apparatus body according to the embodiment.

FIG. 2B is another perspective view of the apparatus body according to the embodiment.

FIG. 3 is a schematic sectional view of a drum cartridge and a development cartridge according to the embodiment.

FIG. 4A illustrates how to attach and detach the drum cartridge according to the embodiment.

FIG. 4B illustrates how to attach and detach the drum cartridge according to the embodiment.

FIG. 5A is a perspective view of the drum cartridge and the development cartridge according to the embodiment.

FIG. 5B is another perspective view of the drum cartridge and the development cartridge according to the embodiment.

FIG. 6 is a sectional view of the drum cartridge and the development cartridge according to the embodiment.

FIG. 7A is a perspective view illustrating a configuration of a charger according to the embodiment.

FIG. 7B is another perspective view illustrating the configuration of the charger according to the embodiment.

FIG. 8A is a side view of the development cartridge according to the embodiment, illustrating a right end portion thereof.

FIG. 8B is a perspective view of the development cartridge according to the embodiment, illustrating the right end portion thereof.

FIG. 9A illustrates a configuration at a right end portion of the drum cartridge according to the embodiment.

FIG. 9B illustrates the configuration at the right end portion of the drum cartridge according to the embodiment.

FIG. 9C illustrates the configuration at the right end portion of the drum cartridge according to the embodiment.

FIG. 9D illustrates the configuration at the right end portion of the drum cartridge according to the embodiment.

FIG. 9E illustrates the configuration at the right end portion of the drum cartridge according to the embodiment.

FIG. 10A illustrates a configuration of supporting a cleaning roller and a collecting roller according to the embodiment.

FIG. 10B illustrates the configuration of supporting the cleaning roller and the collecting roller according to the embodiment.

FIG. 11A illustrates contact points between the apparatus body and the cartridges according to the embodiment.

FIG. 11B illustrates the contact points between the apparatus body and the cartridges according to the embodiment.

FIG. 11C illustrates the contact points between the apparatus body and the cartridges according to the embodiment.

FIG. 12 illustrates an arrangement of the contact points provided on the drum cartridge and the development cartridge according to the embodiment.

### DESCRIPTION OF THE EMBODIMENTS

An image forming apparatus 100 according to an embodiment of the present disclosure will now be described.

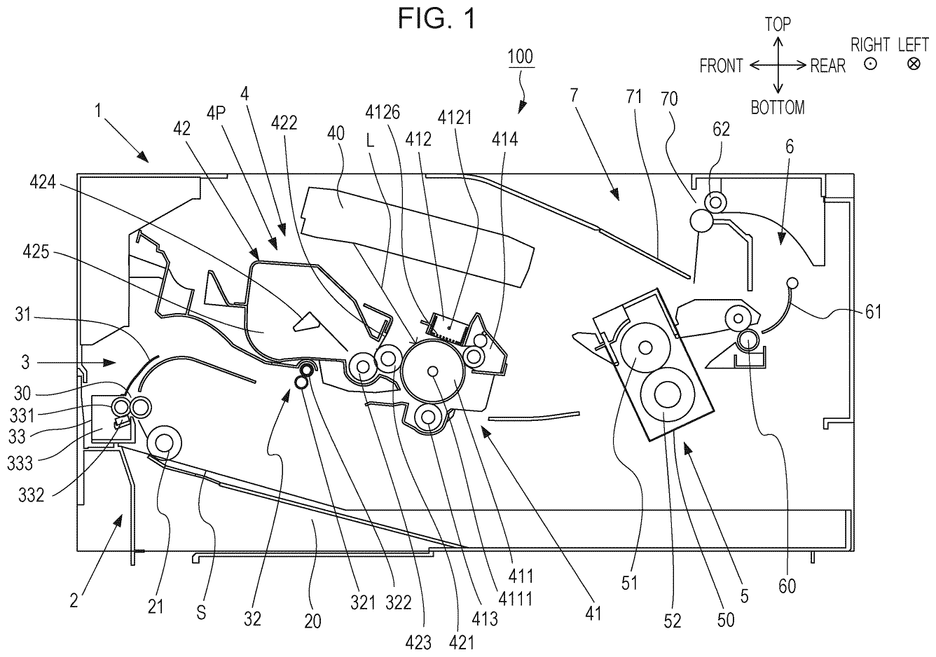

In the following description and the drawings to be referred to below, assuming that the image forming apparatus 100 is installed horizontally, the vertical direction (the direction of gravity and the direction opposite thereto) is defined as the top-bottom direction. The direction of the rotation axis of a photoconductor drum 411 (image carrying member), included in the image forming apparatus 100, is defined as the left-right direction. The direction orthogonal to both the top-bottom direction and the left-right direction is defined as the front-rear direction. The “left”, “right”, “front”, and “rear” sides are based on the definitions provided in FIG. 1.

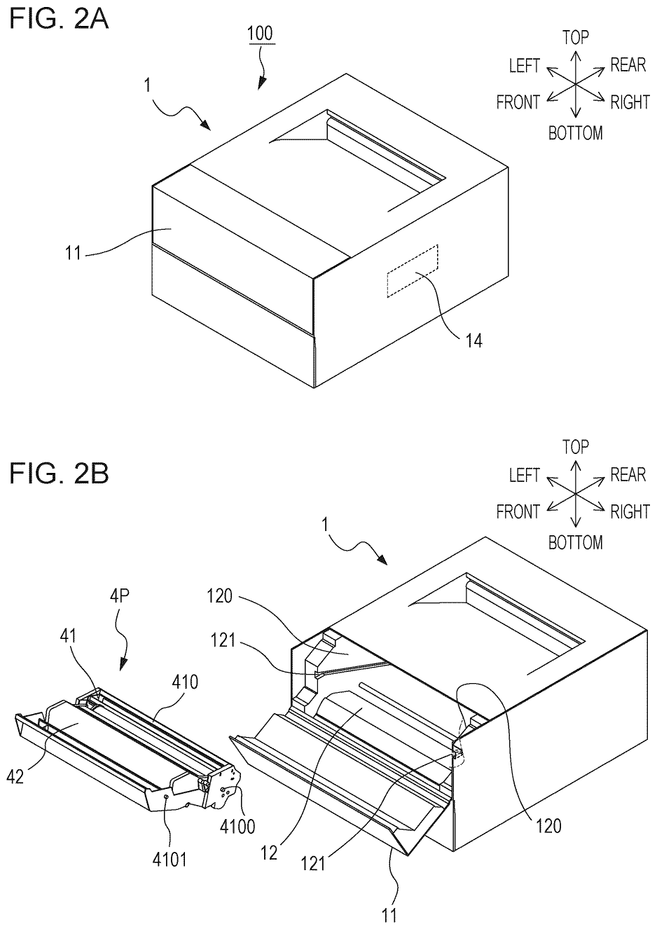

FIG. 1 is a sectional view of the image forming apparatus 100, taken along a virtual plane perpendicular to the left-right direction. FIGS. 2A and 2B are perspective views of an apparatus body 1.

As illustrated in FIG. 1, the image forming apparatus 100 includes the apparatus body 1, a feeding section 2, a conveying section 3, an image forming section 4, a fixing section 5, a discharging section 6, and a stacking section 7. The apparatus body 1 is a housing that houses the feeding section 2, the conveying section 3, the image forming section 4, the fixing section 5, and the discharging section 6. The apparatus body 1 includes frame members and exterior members. The feeding section 2 is located at a lower part of the apparatus body 1. The conveying section 3 is located at a front part of the apparatus body 1. The image forming section 4 is located at a central part of the apparatus body 1. The fixing section 5 and the discharging section 6 are located at a rear part of the apparatus body 1. The stacking section 7 is located at an upper part of the apparatus body 1.

At least part of the image forming section 4 constitutes a unit (process cartridge 4P) attachable to and detachable from the apparatus body 1. The process cartridge 4P will be detailed separately below.

The feeding section 2 is an exemplary feeding unit configured to feed out a recording material S (recording medium). The conveying section 3 is an exemplary conveying unit configured to convey the recording material S from the feeding section 2 to the image forming section 4. The image forming section 4 is an exemplary image forming unit configured to form an image on the recording material S. The fixing section 5 is an exemplary fixing unit configured to fix the image formed on the recording material S. The discharging section 6 is an exemplary discharge unit configured to convey the recording material S having the fixed image to the stacking section 7. The stacking section 7 is an exemplary stacking unit on which the recording material S having undergone image formation is to be stacked.

The image forming apparatus 100 is capable of performing an image forming operation in which an image is formed on a recording material S through an electrophotographic process while the recording material S is being conveyed. In the image forming operation, a recording material S is fed out by the feeding section 2, is conveyed to the image forming section 4 by the conveying section 3, and is subjected to image formation (transfer of a developer image) by the image forming section 4. The recording material S having an image formed thereon is conveyed to the fixing section 5 and is subjected to an image fixing process. The recording material S having the image fixed thereon is discharged to the outside of the apparatus body 1 by the discharging section 6 and is stacked onto the stacking section 7.

### Feeding Section and Conveying Section

The feeding section 2 and the conveying section 3 will now be described with reference to FIG. 1. The feeding section 2 according to the present embodiment includes a cassette 20 and a pickup part 21. The cassette 20 is a container configured to contain a stack of recording materials S. The recording material S may be any of various kinds of sheet members with different sizes and/or different materials, including the following: paper such as plain paper and cardboard; surface-treated sheet members such as coated paper; specially shaped sheet members such as an envelope and index paper; plastic film; and fabric. The pickup part 21 is a unit configured to pick up and deliver the recording materials S one by one from the cassette 20. The pickup part 21 is, for example, a feed roller provided above an inner plate, which is movable up and down inside the cassette 20. The pickup part 21 is configured to rotate while being in contact with the topmost one of the recording materials S stacked on the inner plate.

The conveying section 3 includes an upstream conveying-roller pair 30, a conveyance guide 31, a downstream conveying-roller pair 32, and a paper-lint collector 33. The upstream conveying-roller pair 30 is a roller pair configured to receive the recording material S from the feeding section 2 and convey the recording material S further on. The conveyance guide 31 is a guide that regulates the path along which the recording material S moves. The downstream conveying-roller pair 32 is a roller pair configured to convey the recording material S to the image forming section 4.

The paper-lint collector 33 is a unit configured to collect paper lint (foreign matter) generated from the recording material S that is being conveyed toward the image forming section 4. The term “paper lint” used herein is a general term referring to fibers and fillers constituting paper, dust adhered to paper, and the like. The paper-lint collector 33 includes a paper-lint attracting roller 331, a scraper 332, and a paper-lint collecting case 333. The paper-lint attracting roller 331 also serves as one of the rollers constituting the upstream conveying-roller pair 30. The paper-lint attracting roller 331 electrostatically attracts paper lint by coming into contact with the recording material S that is being conveyed. The scraper 332 scrapes the paper lint attracted by the paper-lint attracting roller 331. The paper-lint collecting case 333 collects the paper lint scraped off.

The downstream conveying-roller pair 32 is constituted by a first conveying roller 321 and a second conveying roller 322. In the present embodiment, the first conveying roller 321 is included in the apparatus body 1, and the second conveying roller 322 is included in a drum cartridge 41. In the present embodiment, the second conveying roller 322 rotates by following the first conveying roller 321, which is rotated by a drive source included in the apparatus body 1. Alternatively, the second conveying roller 322 may be a roller that is directly rotated by a drive source.

How the feeding section 2 and the conveying section 3 operate in the image forming operation will now be described. When an image forming operation is started, the pickup part 21 of the feeding section 2 and the upstream conveying-roller pair 30 and the downstream conveying-roller pair 32 of the conveying section 3 are rotated by driving forces generated by corresponding drive sources included in the apparatus body 1. The pickup part 21 feeds out the recording materials S from the cassette 20 one by one. Each of the recording materials S thus fed out is conveyed by the upstream conveying-roller pair 30 and the downstream conveying-roller pair 32 toward a transfer part defined in the image forming section 4. The recording material S may be conveyed as follows. The recording material S conveyed by the upstream conveying-roller pair 30 may be caused to come into contact with the downstream conveying-roller pair 32 that is not rotating so that any skew in the recording material S can be corrected, and the conveyance of the recording material S by the downstream conveying-roller pair 32 may be started synchronously with the operation of the image forming section 4.

### Image Forming Section

The image forming section 4 will now be described with reference to FIGS. 1, 2A, and 2B. As illustrated in FIG. 1, the image forming section 4 includes the process cartridge 4P and a laser scanner unit 40. The process cartridge 4P includes the drum cartridge 41 (photoconductor-drum unit) and a development cartridge 42 (development unit). The drum cartridge 41 includes the photoconductor drum 411. As illustrated in FIG. 2A, the apparatus body 1 includes a bias generator 14 at a right side portion thereof. The bias generator 14 is a bias generating unit (voltage generator) configured to generate high voltages (bias voltages) to be used in an electrophotographic process and to apply the high voltages to the image forming section 4. The bias generator 14 is a high-voltage board carrying a voltage generating circuit configured to generate high voltages by receiving electric power supplied from an external power source (commercial power source) to which the image forming apparatus 100 is connected.

The laser scanner unit 40 is an exposure device (latent-image-forming unit) configured to form a latent image through exposure performed on the photoconductor drum 411, which serves as an image carrying member. In the image forming operation, a controller included in the image forming apparatus 100 processes image information received from, for example, an external device, thereby generating a signal (video signal) for activating the laser scanner unit 40. In response to the video signal, the laser scanner unit 40 applies laser light L to the photoconductor drum 411, thereby forming a latent image (electrostatic latent image) on the surface of the photoconductor drum 411. The exposure device may be a light-emitting-diode (LED) exposure device including a number of LEDs, serving as light sources, arranged in the direction of the rotation axis of the photoconductor drum 411.

The bias generator 14 generates high voltages in accordance with a command received from the controller of the image forming apparatus 100. The bias generator 14 is electrically connected to objects of high-voltage application, which are included in the process cartridge 4P, through contact points provided on the apparatus body 1 and contact points provided on the process cartridge 4P that are in contact with each other as to be described below. The values of the high voltages to be generated by the bias generator 14 and when to start/stop the application of the high voltages are controlled by the controller of the image forming apparatus 100.

As illustrated in FIG. 1, the drum cartridge 41 includes the photoconductor drum 411, a charger 412, a transfer roller 413, a cleaner 414, and the second conveying roller 322. The photoconductor drum 411 is an image carrying member configured to carry a toner image. The photoconductor drum 411 includes a circular columnar base member and a photosensitive layer. The base member is made of metal and includes a drum shaft 4111. The photosensitive layer is made of an organic photosensitive material or the like and is formed over the outer periphery of the base member. The photoconductor drum 411 is rotatably supported at the drum shaft 4111 thereof by a frame member of the drum cartridge 41.

The charger 412 is a charging unit configured to electrically charge the photoconductor drum 411. The transfer roller 413 is a transfer unit configured to transfer the toner image carried by the photoconductor drum 411 to the recording material S. The cleaner 414 is a cleaning unit configured to remove foreign matter such as paper lint (hereinafter referred to as residual matter) adhered to the photoconductor drum 411.

The development cartridge 42 includes a developing roller 421, a developing blade 422, a supply roller 423, a conveying paddle 424, and a toner container 425. The developing roller 421 is a toner carrying member (developer carrying member) configured to carry toner serving as a developer. The developing roller 421 also serves as a developing member configured to develop the electrostatic latent image into a toner image by supplying the toner carried thereon to the photoconductor drum 411 when receiving a predetermined bias. The developing blade 422 is a regulating unit configured to regulate the thickness of a layer of the toner carried by the developing roller 421. The supply roller 423 is a supply unit configured to supply toner to the developing roller 421. The conveying paddle 424 is a toner conveying unit configured to convey toner to the supply roller 423. The toner container 425 is a toner containing unit configured to contain toner.

The charger 412 according to the present embodiment is a scorotron charging device. Specifically, the charger 412 includes a charging wire 4121 (corona-discharge wire) and a grid plate 4126.

A charging bias is generated by the bias generator 14 and is applied to the charging wire 4121. A grid bias is generated by the bias generator 14 and is applied to the grid plate 4126. The above biases cause corona discharge, which electrically charges the surface of the photoconductor drum 411.

The toner contained in the toner container 425 is conveyed toward the supply roller 423 by the conveying paddle 424 and is supplied to the developing roller 421 by the supply roller 423. The toner received by the developing roller 421 forms a layer whose thickness is regulated by the developing blade 422, and is given electric charge through frictional electrification. A development bias is generated by the bias generator 14 and is applied to the developing roller 421. In accordance with the difference between the potential (development potential) of the developing roller 421 subjected to the development bias and the potential of the electrostatic latent image formed on the photoconductor drum 411, the toner carried by the developing roller 421 is transferred from the developing roller 421 to the photoconductor drum 411.

For example, in a reversal development scheme, a charging bias of a polarity that is the same as the normal polarity of the toner is applied to the charging wire 4121, whereby the surface of the photoconductor drum 411 is charged to a potential (dark-part potential) of a polarity that is the same as the normal polarity of the toner. The laser scanner unit 40 applies the laser light L to an area where an image is to be formed (an image area), thereby reducing the surface potential of the photoconductor drum 411 in the image area to a bright-part potential, which is closer to 0 V than the dark-part potential. The development potential is set between the dark-part potential and the bright-part potential. Therefore, at a development part where the developing roller 421 and the photoconductor drum 411 face each other, while the image area defined on the photoconductor drum 411 receives the toner from the developing roller 421, the area other than the image area (a non-image area) does not receive the toner but leaves the toner on the developing roller 421. Thus, a toner image is formed on the surface of the photoconductor drum 411 while the surface of the photoconductor drum 411 passes through the development part.

The toner image formed on the photoconductor drum 411 is transferred from the photoconductor drum 411 to a recording material S conveyed from the conveying section 3 while the recording material S is passing through the transfer part of the image forming section 4 (a nip part formed between the photoconductor drum 411 and the transfer roller 413). A transfer bias is generated by the bias generator 14 and is applied to the transfer roller 413. The transfer bias is set to a voltage value of a polarity opposite to the normal polarity of the toner.

Residual matter, such as paper lint moved from the recording material S to the photoconductor drum 411 and toner particles not transferred to the recording material S (transfer-residue toner particles), generated while the recording material S passes through the transfer part is removed from the surface of the photoconductor drum 411 by the cleaner 414.

### Fixing Section

The fixing section 5 will now be described with reference to FIG. 1. The fixing section 5 includes a fixing frame member 50, a heating roller 51, and a pressing roller 52.

The fixing frame member 50 is a frame member that unifies the fixing section 5. The fixing frame member 50 supports the heating roller 51 and the pressing roller 52 while allowing the two to rotate. The heating roller 51 is a heating member configured to heat the toner image on the recording material S. The fixing section 5 includes a heat source configured to heat the heating roller 51. The heat source is, for example, a halogen lamp provided inside the heating roller 51. The pressing roller 52 is a pressing member pressed against the heating roller 51 to form a nip part (fixing nip). The heating roller 51 or the pressing roller 52 is rotated by a drive source included in the apparatus body 1.

In the fixing section 5, the heating roller 51 and the pressing roller 52 nip the recording material S at the fixing nip while conveying the recording material S, thereby applying heat and pressure to the toner image on the recording material S. The toner under the heat and pressure is softened and is then fixed to the recording material S, whereby a fixed image is obtained on the recording material S.

### Discharging Section and Stacking Section

The discharging section 6 and the stacking section 7 will now be described with reference to FIG. 1. The discharging section 6 includes a conveying-roller pair 60, a conveyance guide 61, and a discharge-roller pair 62. The stacking section 7 includes a discharge opening 70 and a receiving tray 71. The conveying-roller pair 60 and the discharge-roller pair 62 are conveying members configured to convey the recording material S. The conveyance guide 61 is a guide unit configured to guide the recording material S along a conveyance path.

The conveying-roller pair 60 and the discharge-roller pair 62 are each rotated by a drive source included in the apparatus body 1. The recording material S exited from the fixing section 5 is conveyed by the conveying-roller pair 60. The recording material S conveyed by the conveying-roller pair 60 is guided by the conveyance guide 61 toward the discharge-roller pair 62. The discharge-roller pair 62 is located at the discharge opening 70, which is an opening provided in an outer wall of the apparatus body 1. The discharge-roller pair 62 conveys the recording material S while nipping the recording material S and discharges the recording material S from the inside of the apparatus body 1 to the outside through the discharge opening 70. The recording material S thus discharged is stacked on the receiving tray 71.

### Process Cartridge

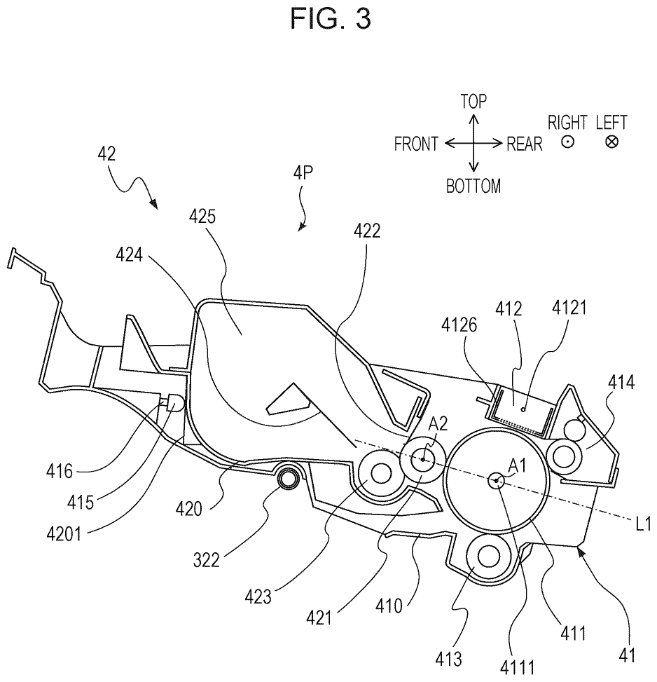

The process cartridge 4P will now be described with reference to FIG. 3. FIG. 3 is a schematic sectional view of the process cartridge 4P. As described above, the process cartridge 4P according to the present embodiment is constituted by the drum cartridge 41 and the development cartridge 42.

The drum cartridge 41 includes a drum frame member 410, in addition to the above-described elements. The drum frame member 410 supports the above-described elements of the drum cartridge 41 (the photoconductor drum 411, the charger 412, the transfer roller 413, the cleaner 414, and the second conveying roller 322). That is, the drum cartridge 41 is a unit obtained by integrating the drum frame member 410 and the plurality of elements supported by the drum frame member 410 together.

As the image forming operation is repeated, the elements such as the photoconductor drum 411 and the transfer roller 413 gradually deteriorate. Furthermore, the residual matter removed by the cleaner 414 is collected to the inside of the cleaner 414.

That is, with the repetition of the image forming operation, the elements of the drum cartridge 41 deteriorate, and/or the capacity inside the cleaner 414 decreases, which indicates the time for replacement of the drum cartridge 41. Since the drum cartridge 41 is detachably attached to the apparatus body 1, it is easy for the user to replace the drum cartridge 41.

The development cartridge 42 includes a development frame member 420, in addition to the above-described elements. The development frame member 420 supports the above-described elements of the development cartridge 42 (the developing roller 421, the developing blade 422, the supply roller 423, the conveying paddle 424, and the toner container 425). That is, the development cartridge 42 is a unit obtained by integrating the development frame member 420 and the plurality of elements supported by the development frame member 420 together.

As the image forming operation is repeated, the elements such as the developing roller 421 and the supply roller 423 gradually deteriorate. Furthermore, the toner contained in the toner container 425 is consumed. That is, with the repetition of the image forming operation, the elements of the development cartridge 42 deteriorate, and/or the toner in the toner container 425 runs out, which indicates the time for replacement of the development cartridge 42.

Since the development cartridge 42 is detachably attached to the apparatus body 1, it is easy for the user to replace the development cartridge 42.

As illustrated in FIG. 3, the drum frame member 410 is provided with a development pressing member 415 (pressing member) and a development pressing spring 416 (urging member). That is, the drum cartridge 41 includes the development pressing member 415 and the development pressing spring 416.

The development pressing member 415 is in contact with a pressure bearing surface 4201, which is provided on the development frame member 420.

The development pressing spring 416 urges the development pressing member 415. The urging force of the development pressing spring 416 presses the development cartridge 42 in such a direction that the developing roller 421 moves toward the photoconductor drum 411 (in such a direction that the rotation axis, A2, of the developing roller 421 moves toward the rotation axis, A1, of the photoconductor drum 411). Thus, in a state where the development cartridge 42 is attached to the drum cartridge 41, the developing roller 421 is in contact with the photoconductor drum 411 with an appropriate contact pressure.

### Attaching/Detaching Process Cartridge

How to attach and detach the drum cartridge 41 will now be described with reference to FIGS. 2A, 2B, 4A, 4B, 5A, and 5B. In the present embodiment, the development cartridge 42 is attached to and detached from the apparatus body 1 together with the drum cartridge 41 and with the development cartridge 42 attached to the drum cartridge 41. Therefore, it can also be stated that the following description describes how to attach and detach the process cartridge 4P to and from the apparatus body 1.

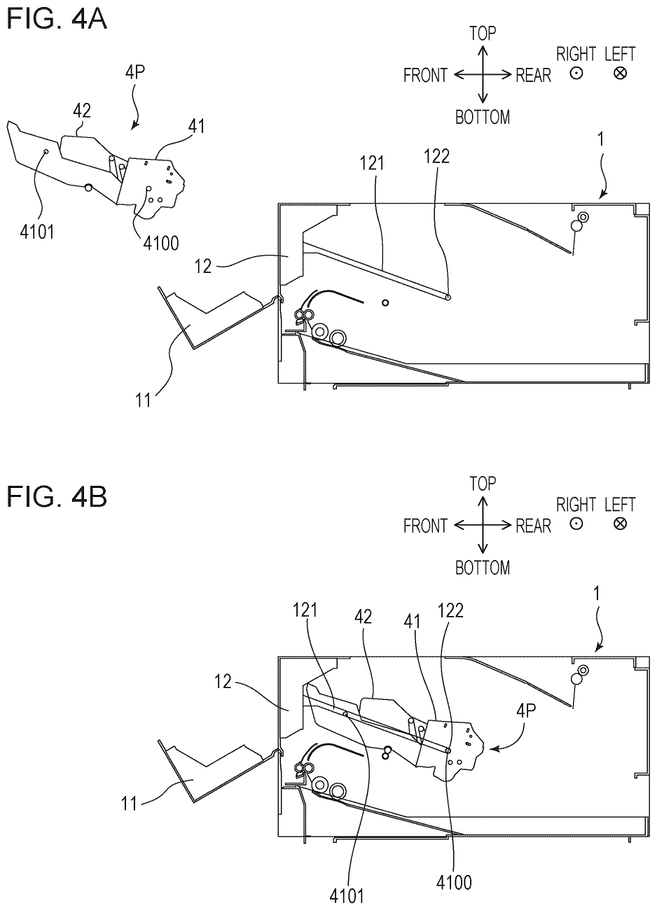

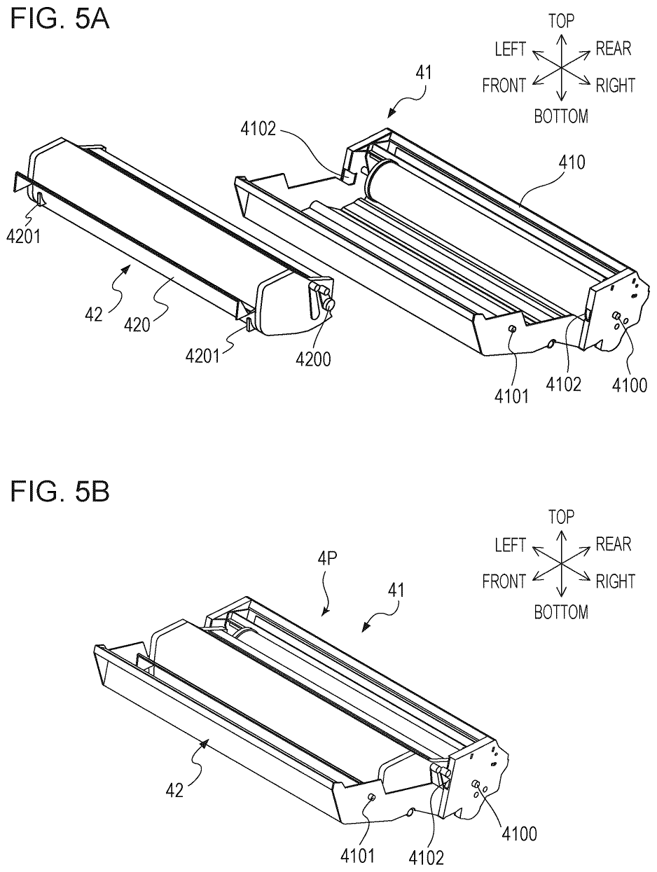

FIGS. 2A and 2B are perspective views of the apparatus body 1. In FIG. 2A, a cartridge door 11 to be described below is closed. In FIG. 2B, the cartridge door 11 is open, and the drum cartridge 41 is outside the apparatus body 1. FIGS. 4A and 4B schematically illustrate how to attach and detach the drum cartridge 41 to and from the apparatus body 1. In FIG. 4A, the drum cartridge 41 is outside the apparatus body 1. In FIG. 4B, the drum cartridge 41 is set in the apparatus body 1. FIGS. 5A and 5B are perspective views of the drum cartridge 41 and the development cartridge 42. In FIG. 5A, the drum cartridge 41 and the development cartridge 42 are detached from each other. In FIG. 5B, the drum cartridge 41 and the development cartridge 42 are joined to each other.

As illustrated in FIG. 2A, the apparatus body 1 has at the front face thereof the cartridge door 11, serving as an opening-and-closing member. The cartridge door 11 is movable between an open position (FIG. 2B) where a cartridge opening 12, provided in the apparatus body 1, is exposed and a closed position (FIG. 2A) where the cartridge opening 12 is closed.

As illustrated in FIG. 2A, when the cartridge door 11 is at the closed position, the entry of external light and foreign matter is prevented. When the cartridge door 11 is opened, the cartridge opening 12 is exposed. Opening the cartridge door 11 allows the user to attach and detach the drum cartridge 41 (process cartridge 4P) through the cartridge opening 12. Furthermore, opening the cartridge door 11 and detaching the drum cartridge 41 from the apparatus body 1 allows the user to remove any recording materials S jammed in the apparatus body 1 (a jam clearing operation).

The apparatus body 1 has a cartridge guiding groove 121. The cartridge guiding groove 121 is provided in each of the left and right inner walls 120 of the apparatus body 1. The left and right inner walls 120 define a space for accommodating the process cartridge 4P. The cartridge guiding groove 121 is a guide part that engages with a portion of the drum cartridge 41 and that regulates the path along which the drum cartridge 41 moves relative to the apparatus body 1.

As illustrated in FIG. 2B, the drum frame member 410 has on the right side face thereof a drum positioning pin 4100 and a drum guide pin 4101. The drum frame member 410 has on the left side face thereof another drum positioning pin and another drum guide pin. The drum positioning pin 4100 is a positioning part for positioning the drum cartridge 41 relative to the apparatus body 1. The drum guide pin 4101 is an orientation regulating part for regulating the orientation of the drum cartridge 41 that is being attached to or detached from the apparatus body 1.

As illustrated in FIG. 4A, a cartridge positioning part 122 is provided at the rear end of the cartridge guiding groove 121. The cartridge positioning part 122 is a positioning part for positioning the drum cartridge 41 relative to the apparatus body 1.

To attach the drum cartridge 41 to the apparatus body 1, as illustrated in FIG. 4A, the drum cartridge 41 is inserted into the apparatus body 1 through the cartridge opening 12. In the process of the insertion, the drum positioning pin 4100 and the drum guide pin 4101 are made to engage with the cartridge guiding groove 121. The drum positioning pin 4100 and the drum guide pin 4101 when engaged with the cartridge guiding groove 121 regulate the movement direction and orientation of the drum cartridge 41. As illustrated in FIG. 4B, when the drum cartridge 41 reaches a position where the drum positioning pin 4100 comes into contact with the cartridge positioning part 122, the attaching of the drum cartridge 41 is complete.

To detach the drum cartridge 41 from the apparatus body 1, the drum cartridge 41 is moved in a direction opposite to the direction for attaching.

The drum cartridge 41 is to be detached from the apparatus body 1 not only for the replacement of the drum cartridge 41 or the development cartridge 42 but also for the jam clearing operation. Since the development cartridge 42 according to the present embodiment is configured to be attached to and detached from the apparatus body 1 together with the drum cartridge 41, the jam clearing operation is easier than in a configuration in which, for example, the development cartridge 42 is configured to be attached to and detached from the apparatus body 1 independently of the drum cartridge 41.

### Attaching/Detaching Development Cartridge

How to attach and detach the development cartridge 42 will now be described with reference to FIGS. 2A, 2B, 3, 5A, and 5B.

As illustrated in FIG. 5A, the drum frame member 410 has a development guide groove 4102 in each of the left and right inner walls thereof. As illustrated in FIG. 5A, the development frame member 420 has a development positioning pin 4200 on the right side face thereof. Furthermore, the development frame member 420 has the pressure bearing surface 4201 at a front part thereof. The pressure bearing surface 4201 is provided one each near the left and right ends of the development frame member 420. As illustrated in FIG. 3, the drum frame member 410 is provided with the development pressing member 415 and the development pressing spring 416 at each of such positions of a front part thereof as to face the respective pressure bearing surfaces 4201.

The development guide groove 4102 is a guide part that guides the development cartridge 42 being attached to or detached from the drum cartridge 41. The development pressing member 415 and the development pressing spring 416 constitute a pressing unit configured to press the developing roller 421 against the photoconductor drum 411. The development positioning pin 4200 is a positioning unit configured to position the development cartridge 42 relative to the drum cartridge 41. The pressure bearing surface 4201 is a contact part that comes into contact with the development pressing member 415.

The development guide groove 4102 has such a width as to allow the development positioning pin 4200 to engage with. The development pressing spring 416 is designed such that the developing roller 421 is pressed against the photoconductor drum 411 with a predetermined pressure.

To attach the development cartridge 42 to the drum cartridge 41, the development guide groove 4102 and the development positioning pin 4200 are aligned with each other. Then, the development cartridge 42 is moved toward the photoconductor drum 411. Furthermore, the development cartridge 42 is pushed down such that the pressure bearing surface 4201 of the development frame member 420 faces the development pressing member 415. Thus, the attaching of the development cartridge 42 to the drum cartridge 41 is complete. To detach the development cartridge 42 from the drum cartridge 41, the above process is performed reversely.

Referring now to FIGS. 2A, 2B, and 6 to 12, an exemplary configuration of the process cartridge 4P according to the present embodiment will be detailed. Note that specific values given as bias voltages in the following description are only exemplary and may be changed according to need.

### Charger

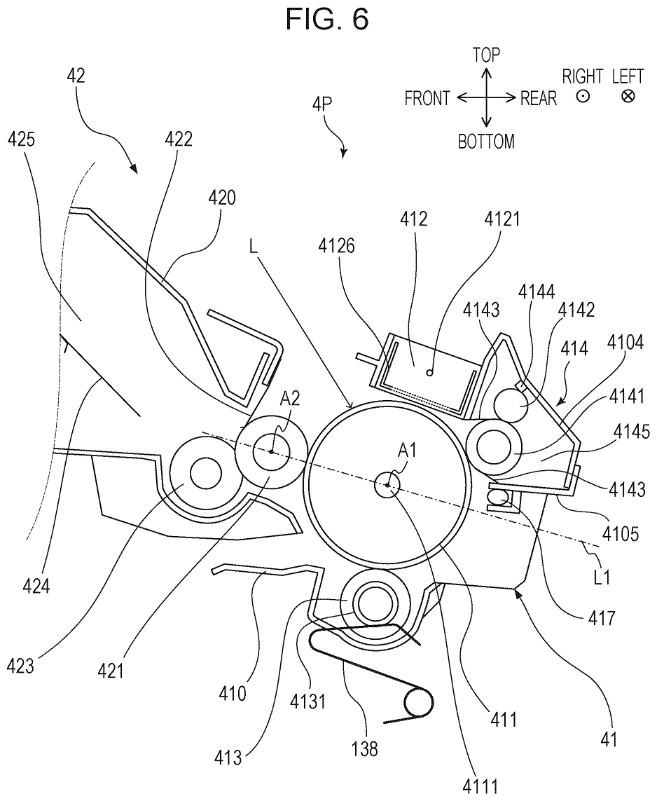

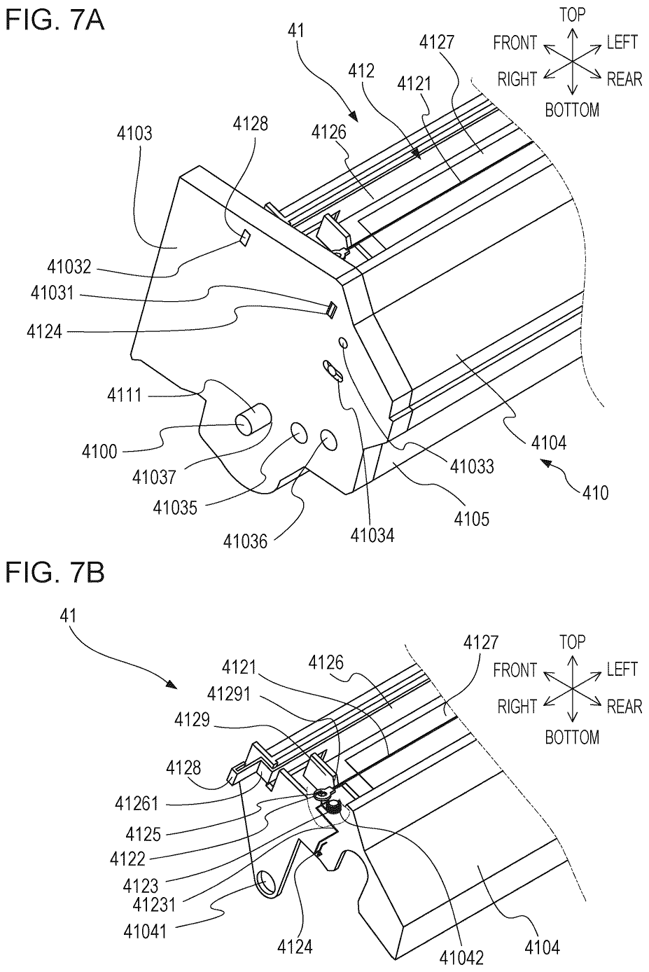

The charger 412 according to the present embodiment will first be described with reference to FIGS. 6, 7A, and 7B. FIG. 6 illustrates part of the drum cartridge 41 and part of the development cartridge 42 in sectional view. FIGS. 7A and 7B are perspective views illustrating a configuration of the charger 412. FIG. 7A is an enlarged perspective view of a right side portion of the drum cartridge 41. FIG. 7B is a perspective view of the right side portion illustrated in FIG. 7A, with the charger 412 exposed. The one-dot chain lines in FIGS. 6, 7A, and 7B are break lines.

As illustrated in FIG. 6, the charger 412 includes the charging wire 4121 and the grid plate 4126. The charging wire 4121 is a discharging member for causing corona discharge. The application of the charging bias generated by the bias generator 14 to the charging wire 4121 causes corona discharge, whereby the surface of the photoconductor drum 411 is electrically charged. The grid plate 4126 is an adjusting member having a function of adjusting the surface potential of the photoconductor drum 411 to be charged with corona discharge. The application of the grid bias generated by the bias generator 14 to the grid plate 4126 makes the surface potential of the photoconductor drum 411 uniform and stable.

For example, a charging bias of about +4500 V is applied to the charging wire 4121, and a grid bias of about +800 V is applied to the grid plate 4126. Thus, the photoconductor drum 411 is electrically charged, which enables the formation of a favorable image.

Referring now to FIGS. 7A and 7B, a configuration of the charger 412 will be described. As illustrated in FIG. 7A, the drum frame member 410 constituting the frame member of the drum cartridge 41 includes a drum upper frame member 4104, a drum lower frame member 4105, and a drum side cover 4103. The drum upper frame member 4104 and the drum lower frame member 4105 are fastened to each other and each extend in the left-right direction. The drum side cover 4103 is provided over right end portions of the drum upper frame member 4104 and the drum lower frame member 4105. The charger 412 is fitted to the drum upper frame member 4104.

The drum side cover 4103 is a cover member constituting at least part of an end face (right side face) of the drum cartridge 41 on one-end side. The outer surface (a surface oriented toward the right side) of the drum side cover 4103 has a wire-electrode opening 41031, where a wire electrode 4124 is exposed; and a grid-electrode opening 41032, where a grid electrode 4128 is exposed.

The outer surface of the drum side cover 4103 further has a drum-shaft positioning hole 41037, through which the drum shaft 4111 extends. The drum shaft 4111 projects rightward from the outer surface of the drum side cover 4103. The distal end of the drum shaft 4111 functions as a drum electrode for the connection between an electrically conductive base member of the photoconductor drum 411 and a ground potential (that is, as a contact part to be in contact with a ground part of the apparatus body 1).

The charging wire 4121 is a piece of wire extending in the left-right direction. The material for the charging wire 4121 is selectable from tungsten, stainless steel, and the like. In the present embodiment, tungsten wire is employed. Tungsten wire is excellent in terms of heat resistance and corrosion resistance. The charging wire 4121 is subjected to the charging bias, which is of high voltage. In this respect, tungsten wire is one of the suitable materials for the charging wire 4121.

The grid plate 4126 is made of a thin metal plate. Specifically, the material for the grid plate 4126 is selectable from stainless steel and plated steel sheet. The grid plate 4126 includes a mesh portion 4127. The mesh portion 4127 is obtained by performing a mesh-making process on the metal plate. The technique for the mesh-making process is selectable from etching, pressing, and the like. Etching is a technique in which the mesh pattern to be made is freely settable. Pressing is a technique in which the degree of freedom in making the mesh pattern is limited, but the processing cost is inexpensive. Either of the techniques may be selected as appropriate for the mesh-making process. The mesh portion 4127 thus obtained allows ions generated by corona discharge to pass through the openings provided therein.

As illustrated in FIG. 7B, when the drum side cover 4103 is removed, a right side portion of the charger 412 is exposed.

The drum upper frame member 4104 has an upper-frame-member positioning hole 41041 at the right end face thereof.

The upper-frame-member positioning hole 41041 is a positioning part. The upper-frame-member positioning hole 41041 is fitted onto the drum shaft 4111 (FIG. 7A) where the photoconductor drum 411 is supported, whereby the drum upper frame member 4104 and the photoconductor drum 411 are positioned.

The drum upper frame member 4104 includes a wire supporting part 4129 and a wire-spring supporting part 41042 at a right side portion thereof. The wire supporting part 4129 is a supporting part that supports the charging wire 4121. The wire-spring supporting part 41042 is a supporting part that supports a wire spring 4123. The wire supporting part 4129 has a V-shaped groove 41291. The V-shaped groove 41291 is a defining part that defines the distance between the charging wire 4121 and the photoconductor drum 411.

The charging wire 4121 has a wire terminal 4122 at an end thereof. The wire terminal 4122 is a metal terminal and is crimped to the charging wire 4121.

The wire spring 4123 is a tension applying member that applies a predetermined tension to the charging wire 4121. The wire spring 4123 includes the wire electrode 4124, a wire engaging portion 4125, and a spring connecting portion 41231. The wire electrode 4124 is an electrode (a contact part for an electric circuit included in the apparatus body 1) for applying a bias to the wire spring 4123. The wire engaging portion 4125 is an engaging part that is in engagement with the wire terminal 4122. The spring connecting portion 41231 is a connecting part that connects the wire spring 4123 and the wire electrode 4124 to each other. The wire electrode 4124 is electrically connected to the charging wire 4121 through the spring connecting portion 41231 and the wire engaging portion 4125.

That is, the wire spring 4123 has both a function as a tension applying member that applies a tension to the charging wire 4121 and a function as an electrode for applying the charging bias to the charging wire 4121. Alternatively, the tension applying member and the electrode for applying the charging bias to the charging wire 4121 may be provided as separate members.

The grid plate 4126 is provided with the grid electrode 4128 at a right end portion thereof. The grid electrode 4128 is an electrode (a contact part for the electric circuit included in the apparatus body 1) for applying a bias to the grid plate 4126. The grid plate 4126 includes a grid connecting portion 41261. The grid connecting portion 41261 is a connecting part that connects the mesh portion 4127 of the grid plate 4126 and the grid electrode 4128 to each other. When the grid plate 4126 is fitted to the drum upper frame member 4104, the grid electrode 4128 is positioned on the right side relative to the right end face of the drum upper frame member 4104. The grid electrode 4128 is electrically connected to the mesh portion 4127 of the grid plate 4126 through the grid connecting portion 41261. Note that the electrode for applying the grid bias to the mesh portion 4127 of the grid plate 4126 may not necessarily need to be a portion of the grid plate 4126 and may be provided as a separate member.

The grid connecting portion 41261 extends frontward relative to the mesh portion 4127. The spring connecting portion 41231 extends rearward relative to the wire engaging portion 4125 and a coil portion of the wire spring 4123. Therefore, at the right side face of the drum cartridge 41, the wire electrode 4124 and the grid electrode 4128 are satisfactorily spaced apart from each other in the front-rear direction, which makes it easier to provide a satisfactory distance between the two electrodes 4124 and 4128.

The wire spring 4123 is supported by the wire-spring supporting part 41042. The wire engaging portion 4125 is in engagement with the wire terminal 4122. The charging wire 4121 receives a predetermined tension under an elastic force exerted by the wire spring 4123. The elastic force of the wire spring 4123 stabilizes the electrical connection between the wire terminal 4122 and the wire engaging portion 4125. When the wire spring 4123 is fitted to the drum upper frame member 4104, the wire electrode 4124 is positioned on the right side relative to the right end face of the drum upper frame member 4104.

The wire spring 4123 is set in such a manner as to pull the wire terminal 4122 toward the lower right. Accordingly, the charging wire 4121 is pulled to the lowest point of the V-shaped groove 41291. With this configuration, a distance from the charging wire 4121 to the photoconductor drum 411 can be maintained at a specified distance.

Thus, the drum upper frame member 4104 contributes to the relative positioning between the charger 412 and the photoconductor drum 411. Specifically, the drum upper frame member 4104 is positioned relative to the drum shaft 4111, and the charging wire 4121 is positioned relative to the drum upper frame member 4104. Furthermore, the drum upper frame member 4104 supports the members that are to be subjected to high-voltage biases, such as the charging wire 4121 and the grid plate 4126.

The drum cartridge 41 is provided at the right side face thereof with the wire electrode 4124 and the grid electrode 4128, which are electrodes to be subjected to high-voltage biases. As a precaution for the leakage of electric current that may occur near such electrodes to be subjected to high-voltage biases, the drum upper frame member 4104 and/or the drum side cover 4103, for example, may be made of a flame-retardant resin material. The drum upper frame member 4104, the drum lower frame member 4105, and the drum side cover 4103 may each be made of a self-extinguishing resin.

For example, the charging wire 4121 is to be subjected to a charging bias of about +4500 V, and the grid plate 4126 is to be subjected to a bias of about +800 V. The wire electrode 4124 and the grid electrode 4128 are satisfactorily spaced apart from each other in the front-rear direction with the provision of the grid connecting portion 41261 and the wire spring 4123 in between. The wire electrode 4124 and the grid electrode 4128 are each an electrode for applying a high-voltage bias. Therefore, it is preferable to use a flame-retardant resin for the drum upper frame member 4104, which supports the charger 412.

The wire electrode 4124 only needs to be electrically connected to the charging wire 4121 and may be provided as, for example, a member separate from the wire spring 4123. The grid electrode 4128 only needs to be electrically connected to the mesh portion 4127 of the grid plate 4126 and may be provided as, for example, a member separate from the grid plate 4126. The wire electrode 4124 and the grid electrode 4128 may each be, for example, a resin molded product formed from an electrically conductive resin material through coinjection molding as a portion of the drum frame member 410. The electrically conductive resin material is, for example, a resin material to which electrical conductivity is given by dispersing an electrically conductive filler such as carbon black into a base resin.

### Development Cartridge

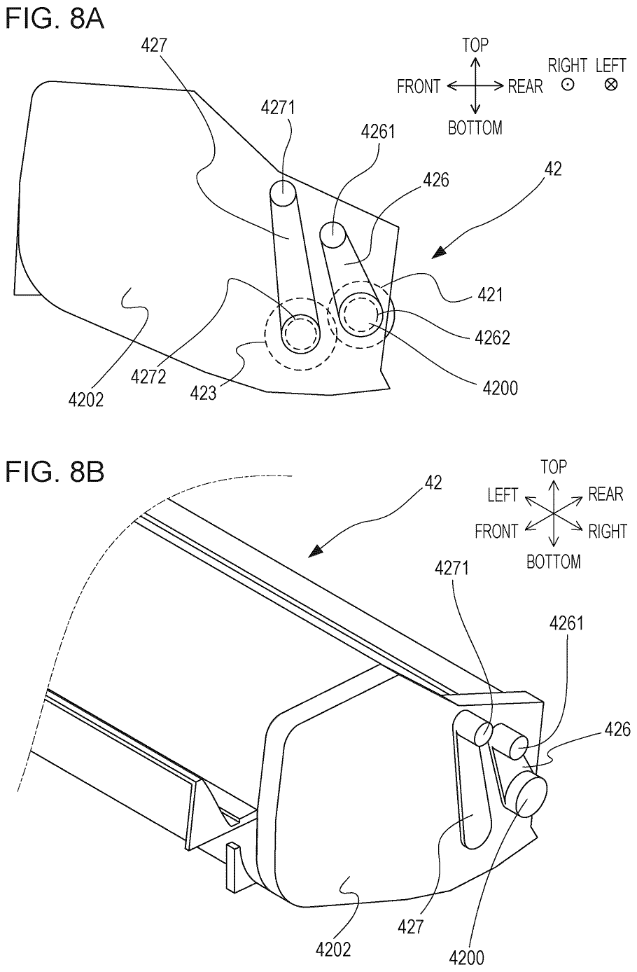

The development cartridge 42 will now be described with reference to FIGS. 6, 8A, and 8B. FIGS. 8A and 8B are enlarged views of a right side portion of the development cartridge 42. FIG. 8A illustrates the right side face of the development cartridge 42. FIG. 8B is a perspective view of the right side portion of the development cartridge 42. The one-dot chain line in FIG. 8B is a break line.

As illustrated in FIG. 6, the toner container 425 is provided inside the development frame member 420 of the development cartridge 42, and the toner container 425 is provided with the conveying paddle 424. The conveying paddle 424 is rotated counterclockwise in FIG. 6 by a drive source included in the apparatus body 1, thereby conveying the toner in the toner container 425 toward the supply roller 423. The supply roller 423 is, for example, a sponge roller including a shaft and a sponge layer provided over the shaft. The supply roller 423 is rotated clockwise in FIG. 6 by a drive source included in the apparatus body 1. The toner conveyed by the conveying paddle 424 is taken in by the sponge layer of the supply roller 423.

The developing roller 421 is, for example, a rubber roller including a shaft and a rubber layer provided over the shaft. The developing roller 421 is rotated clockwise in FIG. 6 by a drive source included in the apparatus body 1. The developing roller 421 and the supply roller 423 are in contact with each other such that the sponge layer of the supply roller 423 is squashed by a predetermined squashing amount. Specifically, at the contact part between the supply roller 423 and the developing roller 421, the supply roller 423 slides on the surface of the developing roller 421 in a counter direction with the sponge layer of the supply roller 43 squashed by the developing roller 421. Thus, the toner taken in by the supply roller 423 is discharged from the sponge layer and is carried by the surface of the developing roller 421. The supply roller 423 is also capable of removing aged toner from the surface of the developing roller 421 when the sponge layer once squashed restores its original volume.

The developing blade 422 is a thin metal plate and may be bent at a distal portion thereof at which the developing blade 422 is in contact with the developing roller 421. The developing blade is in contact with the developing roller 421 with a predetermined contact pressure. The toner carried by the developing roller 421 is regulated to form a layer having a predetermined thickness when passing through the nip part formed between the developing blade 422 and the developing roller 421. The toner carried by the developing roller 421 is rubbed by the developing blade 422, whereby electric charge is given to the toner through frictional electrification.

The charging bias and the grid bias are each set such that, for example, the surface potential of the photoconductor drum 411 charged by the charger 412 becomes about +800 V (hereinafter denoted as a dark-part potential VD). When the surface of the photoconductor drum 411 is exposed to the laser light L applied from the laser scanner unit 40, the exposed area (the image area) comes to have a surface potential of about +100 V (hereinafter denoted as a bright-part potential VL). The developing roller 421 carries toner that has been given a positive electric charge. The developing roller 421 is subjected to a development bias of about 500 V generated by the bias generator 14. Therefore, the toner carried by the developing roller 421 adheres to the area of the surface of the photoconductor drum 411 that has the bright-part potential VL (the image area), not to the area having the dark-part potential VD (the non-image area).

On the other hand, the supply roller 423 is subjected to a supply bias of about +650 V generated by the bias generator 14. The potential difference between the development bias and the supply bias is about 150 V. Accordingly, positively charged particles of the toner move from the supply roller 423 to the developing roller 421. Such a potential difference has an effect of increasing the ratio of the positively charged toner particles in the toner carried by the developing roller 421.

Referring now to FIGS. 8A and 8B, a configuration of the electrodes included in the development cartridge 42 will be described.

As illustrated in FIG. 8A, the development cartridge 42 includes a development side cover 4202 on the right side face thereof. The development side cover 4202 forms a right end face of the development frame member 420.

The development side cover 4202 is provided with a development-power feeding member 426 and a supply-power feeding member 427. The development-power feeding member 426 is electrically connected to the developing roller 421. The supply-power feeding member 427 is electrically connected to the supply roller 423. The development-power feeding member 426 is an electrically conductive member for applying the development bias to the developing roller 421. The supply-power feeding member 427 is an electrically conductive member for applying the supply bias to the supply roller 423.

The development-power feeding member 426 according to the present embodiment includes a development electrode 4261 and a development sliding part 4262. The development electrode 4261 is an electrode (a contact part for the electric circuit included in the apparatus body 1) to which the development bias generated by the bias generator 14 is fed. The development sliding part 4262 is a sliding part that slides on the shaft of the developing roller 421. The supply-power feeding member 427 according to the present embodiment includes a supply electrode 4271 and a supply sliding part 4272. The supply electrode 4271 is an electrode (a contact part for the electric circuit included in the apparatus body 1) to which the supply bias generated by the bias generator 14 is fed. The supply sliding part 4272 is a sliding part that slides on the shaft of the supply roller 423.

The development electrode 4261 and the supply electrode 4271 according to the present embodiment are formed integrally with the development sliding part 4262 and the supply sliding part 4272, respectively. Since the development-power feeding member 426 and the supply-power feeding member 427 according to the present embodiment each include the sliding part that slides on the shaft, an electrically conductive resin material with a high slidability may be selected as the material for the development-power feeding member 426 and the supply-power feeding member 427. Note that the development electrode 4261 and the supply electrode 4271 only need to be electrically connected to the developing roller 421 and the supply roller 423, respectively, and may be provided as components that are separate from the development sliding part 4262 and the supply sliding part 4272.

As illustrated in FIG. 8B, the development electrode 4261 and the supply electrode 4271 each have a shape projecting rightward from the development side cover 4202.

To summarize, the development cartridge 42 includes the development electrode 4261 and the supply electrode 4271. The developing roller 421 is to be subjected to a development bias of, for example, about +500 V through the development electrode 4261. The supply roller 423 is to be subjected to a supply bias of, for example, about +650 V through the supply electrode 4271.

### Cleaner

The cleaner 414 will now be described with reference to FIGS. 2A, 2B, 6, and 9A to 10B.

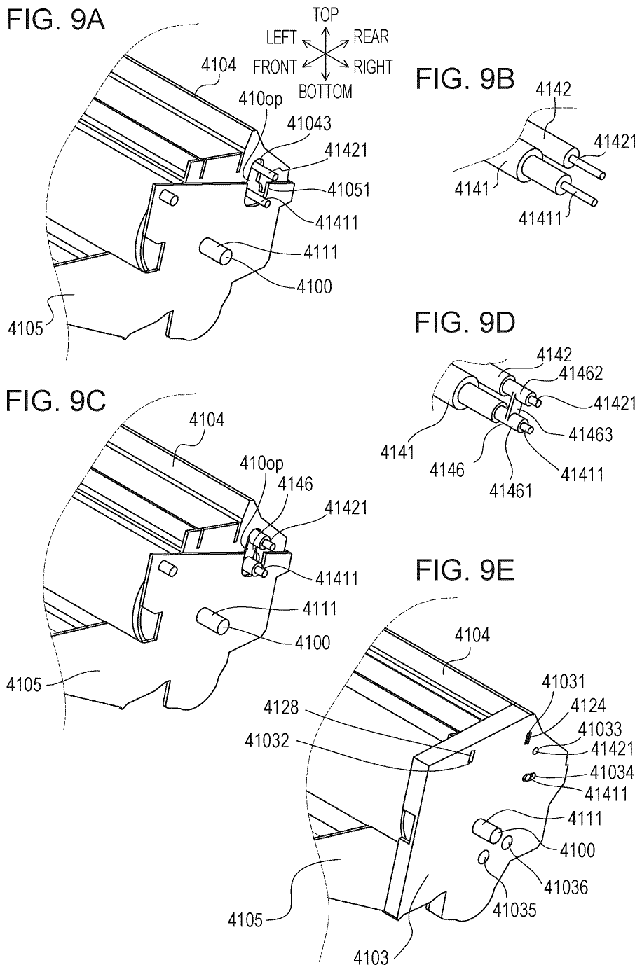

FIGS. 9A to 9E illustrate a configuration at the right side portion of the drum cartridge 41. FIG. 9A illustrates the drum cartridge 41 with the drum side cover 4103 and a cleaner bearing 4146 yet to be fitted thereto. FIG. 9B illustrates only a cleaning roller 4141 and a collecting roller 4142 extracted from FIG. 9A. FIG. 9C illustrates the drum cartridge 41 illustrated in FIG. 9A with the cleaner bearing 4146 fitted thereto. FIG. 9D illustrates the cleaning roller 4141 and the collecting roller 4142 illustrated in FIG. 9C. FIG. 9E illustrates the drum cartridge 41 illustrated in FIG. 9C with the drum side cover 4103 fitted thereto. The one-dot chain lines in FIGS. 9A to 9E are break lines.

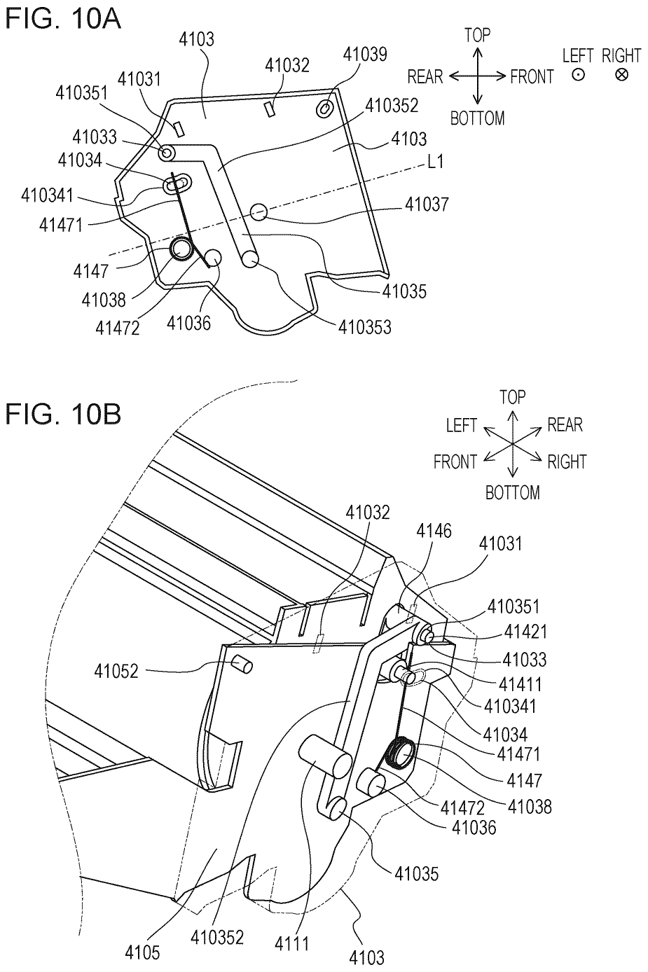

FIGS. 10A and 10B are diagrams for describing how the drum side cover 4103 supports the cleaning roller 4141 and the collecting roller 4142. FIG. 10A is a left side view of the drum side cover 4103. FIG. 10B is an enlarged perspective view of the right side portion of the drum cartridge 41. The one-dot chain line in FIG. 10B is a break line. In FIG. 10B, to illustrate a configuration on the inner side relative to the drum side cover 4103, the drum side cover 4103 is outlined by two-dot chain lines.

As illustrated in FIG. 6, the cleaner 414 includes the cleaning roller 4141, the collecting roller 4142, a sealing member 4143, a scraping member 4144, and a collecting chamber 4145.

The cleaning roller 4141 is a cleaning member that cleans the photoconductor drum 411. The cleaning roller 4141 is in contact with the photoconductor drum 411 at a position downstream of the transfer part and upstream of the charger 412 in the direction of rotation of the photoconductor drum 411. The cleaning roller 4141 collects residual matter remaining on the surface of the photoconductor drum 411. The collecting roller 4142 is a collecting member that collects paper lint from the residual matter collected by the cleaning roller 4141. The scraping member 4144 scrapes off the paper lint collected by the collecting roller 4142. The collecting chamber 4145 receives the paper lint scraped by the scraping member 4144. The sealing member 4143 prevents the paper lint collected to the collecting chamber 4145 from leaking to the outside.

The cleaning roller 4141 is, for example, a sponge roller including a metal shaft and a sponge layer. The material for the sponge is selectable from foamed rubbers having high resistance values, such as ethylene propylene rubber, urethane rubber, and silicone rubber. The material for the sponge may preferably be selected with consideration for cost, ease of processing, hardness, weather resistance, chemical resistance, charging characteristics, and/or resistance value. The present embodiment employs foamed silicone rubber. Employing foamed silicone rubber, which exhibits little change in the elasticity characteristic over a long period, increases the life of the drum cartridge 41.

The cleaning roller 4141 is rotated by a drive source included in the apparatus body 1. The direction of rotation of the cleaning roller 4141 may be a forward direction (the clockwise direction in FIG. 6) relative to the direction of rotation of the photoconductor drum 411 (the counterclockwise direction in FIG. 6).

The collecting roller 4142 is, for example, a metal roller. The collecting roller 4142 is in contact with the cleaning roller 4141 and is rotated by a drive source included in the apparatus body 1. The direction of rotation of the collecting roller 4142 may be a forward direction (the counterclockwise direction in FIG. 6) relative to the direction of rotation of the cleaning roller 4141.

The scraping member 4144 is, for example, a rubber member fixed to the drum upper frame member 4104. The material for the rubber is selectable from urethane rubber, silicone rubber, and the like. In the present embodiment, the scraping member 4144 is set in such a manner as to be in contact at a corner thereof with the collecting roller 4142. Thus, the paper lint adhered to the collecting roller 4142 is effectively scrapable. If the scrapability of the scraping member 4144 is allowed to be lowered because of a shorter life set for the drum cartridge 41 as a whole or any other reasons, the scraping member 4144 may be made of, for example, polyurethane foam sheet, which is of less cost.

The collecting chamber 4145 is a space provided between the drum upper frame member 4104 and the drum lower frame member 4105. Utilizing such a space provided by joining different frame members to each other as the collecting chamber 4145 enables not only a cost reduction but also an increase in the space, compared with a configuration employing a dedicated frame member.

The sealing member 4143 is a pair of sheet members pasted one each to the drum upper frame member 4104 and the drum lower frame member 4105. The material for the sheet members is selectable from polyethylene terephthalate (PET), urethane rubber, and the like. A PET sheet has a smooth surface, which facilitates the movement of the paper lint adhered to the collecting roller 4142 into the collecting chamber 4145. A urethane rubber sheet is less elastic, which allows a reduction in the contact pressure between the sheet and the roller. One end of each of the sealing members 4143 in the short-side direction is fixed to the corresponding frame member, whereas the other end of the sealing member 4143 is in contact with the surface of the cleaning roller 4141, whereby the gaps between the cleaning roller 4141 and the frame members are sealed.

Referring now to FIG. 6, how to collect residual matter remaining on the photoconductor drum 411 will be described. First, the transfer bias to be applied to the transfer roller 413 will be described.

The drum cartridge 41 includes a transfer electrode 4131, which is electrically connected to the transfer roller 413. The transfer electrode 4131 is an electrode (a contact part for the electric circuit included in the apparatus body 1) electrically connected to a body-transfer contact point 138, which is provided on the apparatus body 1. The transfer roller 413 is to be subjected to a transfer bias of, for example, about −2000 V generated by the bias generator 14 (FIG. 2A) and applied through the body-transfer contact point 138 and the transfer electrode 4131. The transfer bias applied to the transfer roller 413 produces a bias electric field, which causes the toner image carried by the photoconductor drum 411 to be transferred to a recording material S when the toner image passes through the nip part (transfer part) formed between the photoconductor drum 411 and the transfer roller 413. In this process, the transfer bias reduces the surface potential of the photoconductor drum 411 in both the image area and the non-image area.

When the recording material S passes through the transfer part, negatively charged matter in the paper lint and the like on the surface of the recording material S moves to the surface of the photoconductor drum 411. Accordingly, the surface of the photoconductor drum 411 that has passed through the transfer part has residual matter including paper lint and/or toner particles not having been transferred to the recording material S (transfer-residue toner particles).

The cleaning roller 4141 is to be subjected to a cleaning bias of, for example, about +500 V. If the surface potential of the photoconductor drum 411 is closer to 0 V than the cleaning bias, negatively charged residual matter such as paper lint is collectable by the cleaning roller 4141. In such a case, positively charged residual matter such as toner particles is not collected by the cleaning roller 4141 but passes through a part where the photoconductor drum 411 and the cleaning roller 4141 face each other.

The reduction in the surface potential of the photoconductor drum 411 that is caused by the transfer bias significantly depends on the kind of the recording material S and/or the environment in which the apparatus body 1 is used. Therefore, it is preferable in some cases that the drum cartridge 41 include a pre-exposure device 417. The pre-exposure device 417 is a static eliminating unit configured to eliminate the electric charge from the surface of the photoconductor drum 411. The pre-exposure device 417 applies light to an area of the surface of the photoconductor drum 411 that has passed through the transfer part, thereby reducing the surface potential to almost 0 V. The pre-exposure device 417 may be a light guide that guides light emitted from a light source provided in the apparatus body 1 toward the surface of the photoconductor drum 411, or a light-emitting-diode (LED) substrate that itself includes a light source. As illustrated in FIG. 6, the pre-exposure device 417 according to the present embodiment includes a light guide provided in a part of the drum lower frame member 4105 that is shaped as a housing. Such a configuration makes it easier to provide a satisfactory distance between the pre-exposure device 417 and the photoconductor drum 411. Employing the pre-exposure device 417 enables the cleaning roller 4141 to clean the photoconductor drum 411 after the surface potential of the photoconductor drum 411 is satisfactorily reduced, which increases the efficiency of cleaning. Instead, the cost of the pre-exposure device 417 is added. Therefore, if the transfer bias satisfactorily reduces the surface potential, the pre-exposure device 417 may be omitted.

The collecting roller 4142 is to be subjected to a collecting bias of, for example, about +600 V. That is, the collecting roller 4142 has a potential difference of about +100 V from the cleaning roller 4141. Accordingly, negatively charged residual matter such as paper lint moves to the collecting roller 4142.

It is known that the efficiency of collection increases by producing a difference in peripheral speed between the photoconductor drum 411 and the cleaning roller 4141 and between the cleaning roller 4141 and the collecting roller 4142. Instead, producing a difference in peripheral speed may promote the increase in torque and/or damage to the rollers in some cases. According to an examination made by the present inventors, a preferable peripheral-speed difference is about 5% to 20%.

The residual matter collected by the collecting roller 4142 is scraped from the collecting roller 4142 by the scraping member 4144 and is collected to the collecting chamber 4145.

Such a configuration enables the cleaner 414 to effectively collect paper lint and the like from the residual matter remaining on the photoconductor drum 411.

On the other hand, positively charged toner particles that are not collected by the cleaner 414 may be collected by the developing roller 421 to the toner container 425 after passing through the part where the photoconductor drum 411 and the cleaning roller 4141 face each other. That is, the image forming section 4 according to the present embodiment may employ a simultaneous development-and-cleaning scheme in which at least some of the transfer-residue toner particles not transferred to the recording material S at the transfer part are collected by the development unit so as to be recycled.

Referring now to FIGS. 9A to 10B, a configuration of supporting the cleaning roller 4141 and the collecting roller 4142 will be described.

As illustrated in FIG. 9A, the drum upper frame member 4104 has an opening upper edge 41043 at the right side face thereof. The drum lower frame member 4105 has an opening lower edge 41051 at the right side face thereof.

When the drum upper frame member 4104 and the drum lower frame member 4105 are joined to each other, the opening upper edge 41043 and the opening lower edge 41051 define a single opening (roller opening 410op).

As illustrated in FIG. 9B, the cleaning roller 4141 includes a cleaning-roller shaft 41411. Likewise, the collecting roller 4142 includes a collecting-roller shaft 41421. As illustrated in FIG. 9A in which the drum upper frame member 4104 and the drum lower frame member 4105 are joined to each other with the cleaning roller 4141 and the collecting roller 4142 fitted thereto, the cleaning-roller shaft 41411 and the collecting-roller shaft 41421 project rightward through the roller opening 410op.

As illustrated in FIG. 9A, there is a gap between the opening upper edge 41043 and the collecting-roller shaft 41421 and between the opening lower edge 41051 and the cleaning-roller shaft 41411. As illustrated in FIG. 9C, the cleaner bearing 4146 is fitted into the gap from the right side.

As illustrated in FIG. 9D, the cleaner bearing 4146 is an integrally molded product that includes a cleaner supporting portion 41461, a collector supporting portion 41462, and a cleaner connecting portion 41463. The cleaner connecting portion 41463 connects the cleaner supporting portion 41461 and the collector supporting portion 41462 to each other. The cleaner supporting portion 41461 is a supporting part that supports the cleaning-roller shaft 41411 while allowing the cleaning-roller shaft 41411 to rotate. The collector supporting portion 41462 is a supporting part that supports the collecting-roller shaft 41421 while allowing the collecting-roller shaft 41421 to rotate. The center distance between the cleaning roller 4141 and the collecting roller 4142 is fixed by the cleaner bearing 4146.

As illustrated in FIG. 9E, the drum side cover 4103 has a collecting-roller positioning hole 41033 and a cleaning-roller guide hole 41034. The collecting-roller positioning hole 41033 is a positioning part for the collecting roller 4142. The collecting-roller shaft 41421 is rotatably fitted in the collecting-roller positioning hole 41033. The collecting roller 4142 is positioned such that the center of the collecting-roller shaft 41421 coincides with the center of the collecting-roller positioning hole 41033.

On the other hand, the cleaning roller 4141 is movable in a direction toward and away from the photoconductor drum 411 along the cleaning-roller guide hole 41034. The cleaning-roller guide hole 41034 is a guide part that regulates the path along which the cleaning roller 4141 moves. The cleaning-roller guide hole 41034 has an arc shape defined about the collecting-roller positioning hole 41033. With the cleaning-roller shaft 41411 engaged with the cleaning-roller guide hole 41034, the cleaning roller 4141 is movable (swingable) about the collecting roller 4142 along the arc-shaped cleaning-roller guide hole 41034. That is, the cleaning roller 4141 is swingable along the cleaning-roller guide hole 41034 while the center distance to the collecting roller 4142 is maintained by the cleaner bearing 4146. The range of swing of the cleaning roller 4141 is limited to the length of the cleaning-roller guide hole 41034.

Thus, the rotation axis of the collecting roller 4142 is positioned relative to the drum side cover 4103. Furthermore, the center distance between the cleaning roller 4141 and the collecting roller 4142 is fixed by the cleaner bearing 4146. Furthermore, the cleaning roller 4141 is swingable about the collecting roller 4142, with the range of swing of the cleaning roller 4141 defined by the drum side cover 4103.

As illustrated in FIGS. 10A and 10B, the drum side cover 4103 has the wire-electrode opening 41031, the grid-electrode opening 41032, the collecting-roller positioning hole 41033, the cleaning-roller guide hole 41034, and a cleaner sliding part 410341. Furthermore, the drum side cover 4103 is provided with a collecting-power feeding member 41035, a cleaning electrode 41036, the drum-shaft positioning hole 41037, a cleaner pressing spring 4147, a spring supporting part 41038, and a cover positioning hole 41039. The collecting-power feeding member 41035 includes a collecting electrode 410353.

The wire-electrode opening 41031 is an opening for exposing the wire electrode 4124 at the right side face of the drum side cover 4103. The grid-electrode opening 41032 is an opening for exposing the grid electrode 4128 at the right side face of the drum side cover 4103. As described above, the collecting-roller positioning hole 41033 is a hole for positioning the collecting-roller shaft 41421 while allowing the collecting-roller shaft 41421 to rotate. As described above, the cleaning-roller guide hole 41034 is a guide part that regulates the path along which the cleaning roller 4141 moves.

The cleaner sliding part 410341 is a slide member that facilitates smooth sliding of the cleaning-roller shaft 41411 along the cleaning-roller guide hole 41034 when the cleaning roller 4141 swings. The cleaner sliding part 410341 is, for example, a cylindrical resin molded product that is press-fitted into the cleaning-roller guide hole 41034.

The collecting-power feeding member 41035 is a power feeding member electrically connected to the collecting roller 4142. The collecting-power feeding member 41035 includes the collecting electrode 410353. The collecting electrode 410353 is an electrode (a contact part for the electric circuit included in the apparatus body 1) for applying the collecting bias to the collecting roller 4142. The cleaning electrode 41036 is an electrode (a contact part for the electric circuit included in the apparatus body 1) for applying the cleaning bias to the cleaning roller 4141. The drum-shaft positioning hole 41037 is a positioning part for positioning the photoconductor drum 411 by receiving the drum shaft 4111.

The cleaner pressing spring 4147 is a pressing unit configured to press the cleaning roller 4141 against the photoconductor drum 411. The spring supporting part 41038 is a supporting part that supports the cleaner pressing spring 4147. The cover positioning hole 41039 is a positioning hole to be used in fitting the drum side cover 4103 over the drum upper frame member 4104 and the drum lower frame member 4105.

The collecting-power feeding member 41035 is a member made of an electrically conductive resin material and including a collecting-roller sliding part 410351, the collecting electrode 410353, and a collector connecting part 410352. The collecting-roller sliding part 410351 is a sliding part that slides on the collecting-roller shaft 41421. The collector connecting part 410352 is a connecting part that connects the collecting-roller sliding part 410351 and the collecting electrode 410353 to each other. The collecting bias applied to the collecting electrode 410353 is applied to the collecting roller 4142 through the collector connecting part 410352 and the collecting-roller sliding part 410351. The collecting-power feeding member 41035 may be a member separate from the drum side cover 4103 or a portion of the drum side cover 4103 that is formed through coinjection molding or the like.

Providing the collector connecting part 410352 enables stable application of the collecting bias to the collecting roller 4142, even if the collecting electrode 410353 is located away from the rotation axis of the collecting roller 4142.

As illustrated in FIG. 10B, the drum lower frame member 4105 has a cover positioning boss 41052. The cover positioning boss 41052 is a positioning part to be used when the drum side cover 4103 is fitted. The drum side cover 4103 has the drum-shaft positioning hole 41037 (FIG. 10A). Fitting the drum-shaft positioning hole 41037 and the drum shaft 4111 to each other determines a reference position. Furthermore, engaging the cover positioning boss 41052 into the cover positioning hole 41039 (FIG. 10A), which has an oblong shape, determines the orientation of the drum side cover 4103 in the direction of rotation about the reference position. The oblong shape of the cover positioning hole 41039 produces an effect of absorbing tolerances in the dimensions and/or assembly of relevant components.

The cleaner pressing spring 4147 includes a pressing portion 41471 and a power feeding portion 41472. The pressing portion 41471 is for pressing the cleaning roller 4141. The power feeding portion 41472 is in contact with the cleaning electrode 41036. The cleaner pressing spring 4147 may be a helical torsion spring including a coil portion held by the spring supporting part 41038, which has a boss shape. The pressing portion 41471 is in engagement with the cleaning-roller shaft 41411 and presses the cleaning roller 4141 toward the photoconductor drum 411. The power feeding portion 41472 is in contact with the cleaning electrode 41036. The cleaning electrode 41036, the cleaner pressing spring 4147, and the cleaning-roller shaft 41411 are electrically connected to one another. Therefore, applying the cleaning bias to the cleaning electrode 41036 applies the cleaning bias to the cleaning roller 4141 through the cleaner pressing spring 4147.

The cleaning electrode 41036 is made of an electrically conductive resin material. The cleaning electrode 41036 may be a member separate from the drum side cover 4103 or may be a portion of the drum side cover 4103 that is formed through coinjection molding or the like.

Providing the cleaner pressing spring 4147 enables stable application of the cleaning bias to the cleaning roller 4141, even if the cleaning electrode 41036 is located away from the rotation axis of the cleaning roller 4141. The cleaner pressing spring 4147 is only an exemplary electrically conductive part that electrically connects the cleaning electrode 41036 and the cleaning roller 4141 to each other. The electrically conductive part may be provided separately from the cleaner pressing spring 4147 serving as an urging member that urges the cleaning roller 4141.

To summarize, the cleaning roller 4141 according to the present embodiment is to be subjected to the cleaning bias from the cleaning electrode 41036, provided on the drum side cover 4103, through the cleaner pressing spring 4147. The collecting roller 4142 according to the present embodiment is to be subjected to the collecting bias from the collecting electrode 410353, provided on the drum side cover 4103, through the collector connecting part 410352 and the collecting-roller sliding part 410351.

As described above, the drum side cover 4103 has the wire-electrode opening 41031 and the grid-electrode opening 41032. That is, the drum side cover 4103 has a function of exposing the electrodes to be subjected to high-voltage biases while covering the other elements. Such a covering function of the drum side cover 4103 prevents the contamination due to external matter and the entry of foreign matter and thus suppresses the occurrence of tracking.

### Contact Points on Apparatus Body

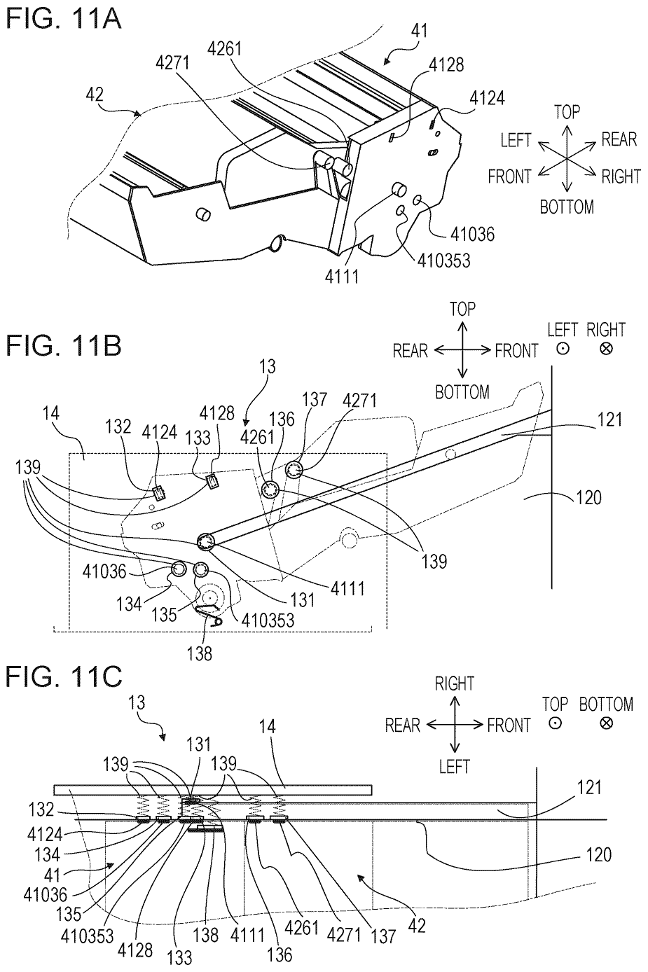

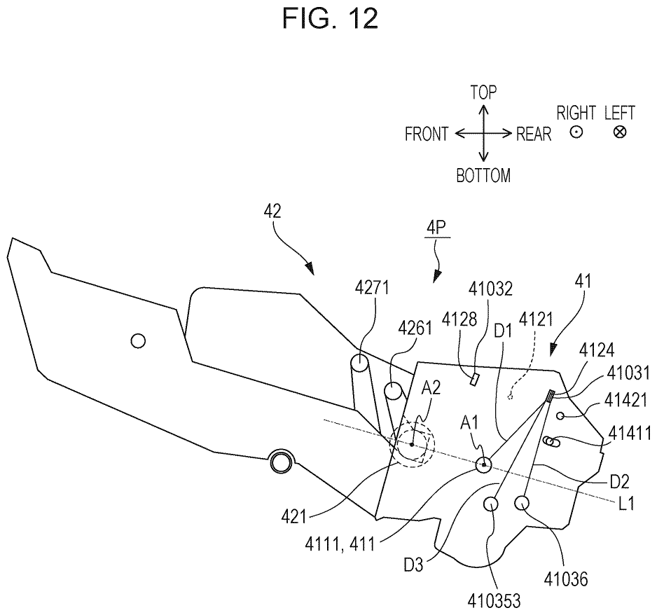

An imaging contact part 13, which is a group of contact points provided on the apparatus body 1 (body contact points), will now be described with reference to FIGS. 11A to 12.

FIGS. 11A to 11C illustrate the electrodes provided on the drum cartridge 41 and the development cartridge 42, and contact parts provided on the apparatus body 1 and through which the biases are to be applied to the electrodes. FIG. 11A is a perspective view of the drum cartridge 41 and the development cartridge 42, illustrating the right side faces thereof. FIG. 11B is a side view of the right inner wall 120 of the apparatus body 1. The bias generator 14 is outlined by a broken line. FIG. 11C is a top view of the right inner wall 120 of the apparatus body 1. In FIGS. 11B and 11C, the drum cartridge 41 and the development cartridge 42 are outlined by two-dot chain lines. FIG. 12 is a side view of the drum cartridge 41 and the development cartridge 42 according to the present embodiment, illustrating the arrangement of the electrodes included therein.

As illustrated in FIG. 11A, the process cartridge 4P has at the right side face thereof the wire electrode 4124, the grid electrode 4128, the cleaning electrode 41036, the collecting electrode 410353, the development electrode 4261, and the supply electrode 4271. These electrodes are to be subjected to high-voltage biases that are necessary for imaging, as described above.

As illustrated in FIG. 11B, the bias generator 14 is provided inside the right inner wall 120 of the apparatus body 1. The imaging contact part 13 is provided on a surface (the surface facing the process cartridge 4P) of the inner wall 120. The imaging contact part 13 includes a body-drum contact point 131, a body-wire contact point 132, a body-grid contact point 133, a body-cleaner contact point 134, a body-collector contact point 135, a body-development contact point 136, a body-supply contact point 137, and the body-transfer contact point 138. The imaging contact part 13 is a connecting unit configured to electrically connect the bias generator 14 and the electrodes included in the drum cartridge 41 and the development cartridge 42 to each other.

The body-drum contact point 131 is a contact point that is in contact with the drum shaft 4111 (drum electrode) of the photoconductor drum 411 in the state where the process cartridge 4P is attached to the apparatus body 1. With the body-drum contact point 131 being in contact with the drum shaft 4111, the electrically conductive base member of the photoconductor drum 411 is electrically connected to the ground part of the apparatus body 1 (the electrically conductive base member is grounded). The ground part of the apparatus body 1 is, for example, a metal frame member included in the image forming apparatus 100.

The body-wire contact point 132 is a contact point that is in contact with the wire electrode 4124 in the state where the process cartridge 4P is attached to the apparatus body 1. With the body-wire contact point 132 being in contact with the wire electrode 4124, the bias generator 14 and the charging wire 4121 are electrically connected to each other, which enables the application of the charging bias from the bias generator 14 to the charging wire 4121. The charging bias according to the present embodiment is, for example, about +4500 V.

The body-grid contact point 133 is a contact point that is in contact with the grid electrode 4128 in the state where the process cartridge 4P is attached to the apparatus body 1. With the body-grid contact point 133 being in contact with the grid electrode 4128, the bias generator 14 and the grid plate 4126 are electrically connected to each other, which enables the application of the grid bias from the bias generator 14 to the grid plate 4126. The grid bias according to the present embodiment is, for example, about +800 V.

The body-cleaner contact point 134 is a contact point that is in contact with the cleaning electrode 41036 in the state where the process cartridge 4P is attached to the apparatus body 1. With the body-cleaner contact point 134 being in contact with the cleaning electrode 41036, the bias generator 14 and the cleaning roller 4141 are electrically connected to each other, which enables the application of the cleaning bias from the bias generator 14 to the cleaning roller 4141. The cleaning bias according to the present embodiment is, for example, about +500 V.

The body-collector contact point 135 is a contact point that is in contact with the collecting electrode 410353 in the state where the process cartridge 4P is attached to the apparatus body 1. With the body-collector contact point 135 being in contact with the collecting electrode 410353, the bias generator 14 and the collecting roller 4142 are electrically connected to each other, which enables the application of the collecting bias from the bias generator 14 to the collecting roller 4142. The collecting bias according to the present embodiment is, for example, about +600 V.

The body-development contact point 136 is a contact point that is in contact with the development electrode 4261 in the state where the process cartridge 4P is attached to the apparatus body 1. With the body-development contact point 136 being in contact with the development electrode 4261, the bias generator 14 and the developing roller 421 are electrically connected to each other, which enables the application of the development bias from the bias generator 14 to the developing roller 421. The development bias according to the present embodiment is, for example, about +500 V.

The body-supply contact point 137 is a contact point that is in contact with the supply electrode 4271 in the state where the process cartridge 4P is attached to the apparatus body 1. With the body-supply contact point 137 being in contact with the supply electrode 4271, the bias generator 14 and the supply roller 423 are electrically connected to each other, which enables the application of the supply bias from the bias generator 14 to the supply roller 423. The supply bias according to the present embodiment is, for example, about +650 V.

The body-transfer contact point 138 is a contact point that is in contact with the transfer electrode 4131 (see FIG. 6 as well) in the state where the process cartridge 4P is attached to the apparatus body 1. With the body-transfer contact point 138 being in contact with the transfer electrode 4131, the bias generator 14 and the transfer roller 413 are electrically connected to each other, which enables the application of the transfer bias from the bias generator 14 to the transfer roller 413. The transfer bias according to the present embodiment is, for example, about −2000 V.

As illustrated in FIG. 11C, the contact points in the imaging contact part 13 excluding the body-transfer contact point 138 are urged by respective contact-point springs 139 toward the process cartridge 4P (downward in FIG. 11C). The direction of the urging force exerted by each of the contact-point springs 139 is substantially parallel to the left-right direction (the direction of the rotation axis of the photoconductor drum 411). In the state where the process cartridge 4P is attached to the apparatus body 1, the contact points in the imaging contact part 13 are in pressure contact with the respective electrodes included in the process cartridge 4P under the urging forces of the contact-point springs 139.

On the other hand, as illustrated in FIGS. 11B and 6, the body-transfer contact point 138 includes an arm portion that is deformable in a direction (the top-bottom direction in FIGS. 11B and 6) intersecting the rotation axis of the photoconductor drum 411, and the arm portion is in contact with the transfer electrode 4131.

As described above, the drum cartridge 41 and the development cartridge 42 according to the present embodiment are to be subjected to, for example, seven kinds of high-voltage biases (wire, grid, cleaning, collecting, development, supply, and transfer biases). The body contact points (132 to 137) for supplying six of the seven high-voltage biases, excluding the transfer bias, are concentratedly provided on the right inner wall 120. Such an arrangement simplifies the configuration of connections between the bias generator 14 and the body contact points. More specifically, it is only necessary to bring one end (left end) of each of the contact-point springs 139 into contact with a corresponding one of the body contact points (132 to 137) and to bring the other end (right end) of each of the contact-point springs 139 into contact with an electrode for high-voltage-bias output that is included in the bias generator 14.

The drum cartridge 41 according to the present embodiment includes the drum shaft 4111 serving as a drum electrode for electrically grounding the photoconductor drum 411. The body contact point (body-drum contact point 131) to be in contact with the drum shaft 4111 is also provided on the right inner wall 120, together with the other body contact points (132 to 137). Such an arrangement further simplifies the configuration of connections between the bias generator 14 and the body contact points.

### Suppressing Tracking

The electrodes included in the drum cartridge 41 and the development cartridge 42 and the body contact points included in the apparatus body 1 are to be subjected to high-voltage biases. Therefore, attention needs to be paid to the occurrence of tracking.

Tracking refers to a phenomenon in which repetition of slight discharge between electrodes due to dust, dirt, moisture, and/or the like forms a track of carbide on the surface of an insulator, and the track of carbide connects between the electrodes.

In particular, the charging bias has a high voltage of, for example, +4500 V. Therefore, it is desirable to suppress the degradation in the insulation characteristic that may be caused by tracking. In the present embodiment, tracking is suppressed by employing an arrangement that allows the electrodes of the process cartridge 4P to be at increased distances from each other. If the distances between the electrodes are large, tracks connecting between such electrodes are less likely to be formed.

As illustrated in FIG. 12, the drum cartridge 41 has on the right side face thereof the wire electrode 4124, the grid electrode 4128, the cleaning electrode 41036, the collecting electrode 410353, and the drum shaft 4111 (drum electrode). The development cartridge 42 has on the right side face thereof the development electrode 4261 and the supply electrode 4271.

To suppress tracking with increased effectiveness, it is desirable to increase the distances between those electrodes that are greatly different in potential. In the present embodiment, one of the high-voltage biases whose voltage value is the greatest is the charging bias (about +4500 V, for example) to be applied to the wire electrode 4124.

One of the high-voltage biases whose potential difference from the charging bias is the greatest is the transfer bias (about −2000 V, for example). In the present embodiment, the transfer electrode 4131 is not present at the right side face of the drum cartridge 41 and is therefore located at a satisfactory distance from the wire electrode 4124. Thus, tracking that may occur between the wire electrode 4124 and the transfer electrode 4131 is suppressed.

The cleaning electrode 41036 is to be subjected to a cleaning bias of, for example, +500 V, which has a relatively large potential difference from the charging bias. Therefore, it is preferable that the cleaning electrode 41036 be located at as large distance as possible from the wire electrode 4124 to which the charging bias is to be applied.

When viewed as illustrated in FIG. 12, a virtual straight line passing through the rotation axis A1 (first rotation axis) of the photoconductor drum 411 and the rotation axis A2 (second rotation axis) of the developing roller 421 is defined as a virtual line L1. According to an examination made by the present inventors, when viewed as illustrated in FIG. 12, it is preferable that the wire electrode 4124 and the cleaning electrode 41036 be located on opposite sides with respect to the virtual line L1. Such an arrangement suppresses the occurrence of tracking between the wire electrode 4124 and the cleaning electrode 41036, which are to be subjected to high-voltage biases having a relatively large potential difference from each other.

In the present embodiment, the rotation axis of the cleaning roller 4141 (the center of the cleaning-roller shaft 41411) is located on the same side as the wire electrode 4124 with respect to the virtual line L1. Furthermore, the cleaning roller 4141 is located on the same side as the charging wire 4121 with respect to the virtual line L1 (see FIG. 6). In such a configuration, the cleaning electrode 41036 is intentionally provided on the side opposite the wire electrode 4124 with respect to the virtual line L1, and an electrically conductive part that electrically connects the wire electrode 4124 and the cleaning-roller shaft 41411 to each other is provided. The electrically conductive part has electrical conductivity. At least part of the electrically conductive part is located on the inner side relative to the drum side cover 4103 and extends in a direction intersecting the virtual line L1 (see FIG. 10A as well). The electrically conductive part according to the present embodiment is the cleaner pressing spring 4147 (FIGS. 10A and 10B), which is in contact with both the cleaning electrode 41036 and the cleaning-roller shaft 41411.

Such a configuration allows the cleaning electrode 41036 to be located on the side opposite the wire electrode 4124 with respect to the virtual line L1, while the rotation axis of the cleaning roller 4141 is located on the same side as the wire electrode 4124 with respect to the virtual line L1. Since at least part of the cleaner pressing spring 4147 (electrically conductive part) is located on the inner side (left side) relative to the drum side cover 4103, which is constituted by an insulator (insulating material), adhesion of dust or the like to the cleaner pressing spring 4147 (electrically conductive part) is prevented.

As described above, the cleaner pressing spring 4147 is an exemplary electrically conductive part. The electrically conductive part may be provided as, for example, an electrically conductive member (metal wire, electrically conductive resin, or the like) separate from the cleaner pressing spring 4147 serving as a pressing unit configured to urge the cleaning roller 4141.

The collecting bias to be applied to the collecting electrode 410353 also has a relatively large potential difference from the charging bias. Therefore, it is preferable that the collecting electrode 410353 be provided at as large distance as possible from the wire electrode 4124. Specifically, when viewed as illustrated in FIG. 12, it is preferable that the wire electrode 4124 and the collecting electrode 410353 be located on opposite sides with respect to the virtual line L1. Such an arrangement suppresses the occurrence of tracking between the wire electrode 4124 and the collecting electrode 410353.

As with the case of the cleaning roller 4141, the rotation axis of the collecting roller 4142 (the center of the collecting-roller shaft 41421) is located on the same side as the wire electrode 4124 with respect to the virtual line L1. In the present embodiment, the collecting electrode 410353 is intentionally provided on the side opposite the wire electrode 4124 with respect to the virtual line L1, and the collector connecting part 410352 that electrically connects the wire electrode 4124 and the collecting-roller shaft 41421 to each other is provided. The collector connecting part 410352, which has electrical conductivity, is located on the inner side relative to the drum side cover 4103 in the left-right direction and intersects the virtual line L1 when viewed in the left-right direction. Such a configuration enables the collecting electrode 410353 to be located on the side opposite the wire electrode 4124 with respect to the virtual line L1, while the rotation axis of the collecting roller 4142 is located on the same side as the wire electrode 4124 with respect to the virtual line L1.

As a variation, the inner surface of the cleaning-roller guide hole 41034 may be formed of an electrically conductive resin material having slidability so as to serve as a cleaning electrode part for applying the cleaning bias. In such a variation, the cleaning electrode 41036 according to the above embodiment becomes unnecessary, which reduces the cost of the drum cartridge 41. However, it may be difficult to provide a satisfactory distance between the wire electrode 4124 and the cleaning electrode part.

As another variation, the collecting electrode 410353 may be provided near the collecting-roller shaft 41421. In such a variation, the size of the collecting-power feeding member 410353 is reduced, which leads to a cost reduction. However, it becomes difficult to provide a satisfactory distance between the wire electrode 4124 and the collecting electrode 410353.

According to the present embodiment, a satisfactory distance is provided between the wire electrode 4124 and the cleaning electrode 41036 and between the wire electrode 4124 and the collecting electrode 410353.

Hereinafter, the distance (shortest distance) between the wire electrode 4124 and the drum shaft 4111 (drum electrode) when viewed as illustrated in FIG. 12 is denoted by D1. Furthermore, the distance (shortest distance) between the wire electrode 4124 and the cleaning electrode 41036 when viewed as illustrated in FIG. 12 is denoted by D2. Furthermore, the distance (shortest distance) between the wire electrode 4124 and the collecting electrode 410353 when viewed as illustrated in FIG. 12 is denoted by D3. The phrase “when viewed as illustrated in FIG. 12” means that when the process cartridge 4P is viewed in the direction of the rotation axis A1 (first rotation axis) of the photoconductor drum 411.

According to an examination made by the present inventors, it has been found that a distance between electrodes that is greater than or equal to the distance D1 between the wire electrode 4124 and the drum shaft 4111 more assuredly prevents the occurrence of tracking even for a combination of electrodes that are to be subjected to high-voltage biases having a potential difference of 4500 V from each other.

Hence, it is preferable that the cleaning electrode 41036 be located such that D1<D2 is satisfied. In other words, it is preferable that the distance D2 (second distance) between the wire electrode 4124 and the cleaning electrode 41036 be longer than the distance D1 (first distance) between the wire electrode 4124 and the drum shaft 4111 (drum electrode). Such a configuration more assuredly prevents the occurrence of tracking between the wire electrode 4124 and the cleaning electrode 41036.

Furthermore, it is preferable that the collecting electrode 410353 be located such that D1<D3 is satisfied. In other words, it is preferable that the distance D3 (third distance) between the wire electrode 4124 and the collecting electrode 410353 be longer than the distance D1 (first distance) between the wire electrode 4124 and the drum shaft 4111 (drum electrode). Such a configuration more assuredly prevents the occurrence of tracking between the wire electrode 4124 and the collecting electrode 410353.

The cleaning electrode 41036 is to be subjected to a cleaning bias of the same polarity (+500 V, for example) as the charging bias. Accordingly, the potential difference between the charging bias and the cleaning bias is smaller than the potential difference between the charging bias and the ground potential (the potential of the drum electrode). Therefore, the relationship of D1<D2 more assuredly prevents the occurrence of tracking, although there is no problem with a configuration in which, for example, D2 is slightly smaller than D1. Likewise, the collecting electrode 410353 is to be subjected to a collecting bias of the same polarity (+600 V, for example) as the charging bias. Accordingly, the potential difference between the charging bias and the collecting bias is smaller than the potential difference between the charging bias and the ground potential (the potential of the drum electrode). Therefore, the relationship of D1<D3 more assuredly prevents the occurrence of tracking, although there is no problem with a configuration in which D3 is slightly smaller than D1.

The cleaning bias and the collecting bias are of the same polarity as the charging bias. However, the collecting bias has a higher voltage than the collecting bias. Accordingly, the potential difference between the charging bias and the collecting bias is smaller than the potential difference between the charging bias and the cleaning bias. Therefore, it is preferable that the distance D2 (second distance) between the wire electrode 4124 and the cleaning electrode 41036 be longer than the distance D3 (third distance) between the wire electrode 4124 and the collecting electrode 410353. Satisfying the relationship of D2>D3 more assuredly prevents the occurrence of tracking, with no unnecessary increase in the size of the drum cartridge 41.

In the present embodiment, when viewed as illustrated in FIG. 12, the distance from the charging wire 4121 to the wire electrode 4124 is shorter than the distance from the rotation axis of the cleaning roller 4141 to the cleaning electrode 41036. The shorter the distance from the charging wire 4121 to the wire electrode 4124, the shorter the path of electrical conduction along which a higher-voltage bias is to be applied. According to the present embodiment, with consideration for securing a satisfactory distance between the wire electrode 4124 and the cleaning electrode 41036, the path of electrical conduction from the charging wire 4121 to the wire electrode 4124 is allowed to be shortened.

### Other Embodiments

While the above embodiment relates to a cartridge including the charger 412 that is a scorotron charging device, the charger 412 may be, for example, a corotron charging device. Even if a corotron charging device is employed, the configurations of the charger 412 and the drum cartridge 41 may be the same as those of the above embodiment, except that the grid plate 4126 and the grid electrode 4128 according to the above embodiment are omitted.

The above embodiment takes an exemplary case where the cleaning member and the collecting member are each a roller member (the cleaning roller 4141 or the collecting roller 4142). The cleaning member and/or the collecting member is not limited to a roller member and may be, for example, a brush member including a rotatable shaft studded with electrically conductive brush fibers.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-212268, filed Dec. 5, 2024, which is hereby incorporated by reference herein in its entirety.

What is claimed is:

1. A cartridge comprising:
(i) a photoconductor-drum unit including
a photoconductor drum configured to rotate about a first rotation axis,
a charging wire configured to charge a surface of the photoconductor drum, and
a cleaning member configured to clean the surface of the photoconductor drum,
the photoconductor-drum unit having an end face on one-end side in a direction of the first rotation axis, the end face being provided with
a wire electrode electrically connected to the charging wire, and
a cleaning electrode electrically connected to the cleaning member; and
(ii) a development unit detachably attached to the photoconductor-drum unit and including a developing roller configured to rotate about a second rotation axis and to supply developer to the photoconductor drum,
wherein when viewed in the direction of the first rotation axis, the wire electrode and the cleaning electrode are located on opposite sides with respect to a virtual straight line passing through the first rotation axis and the second rotation axis.

2. The cartridge according to claim 1,
wherein the photoconductor-drum unit includes a drum electrode provided at the end face and electrically connected to the photoconductor drum, and
wherein defining a distance between the wire electrode and the drum electrode when viewed in the direction of the first rotation axis as a first distance; and a distance between the wire electrode and the cleaning electrode when viewed in the direction of the first rotation axis as a second distance,
the second distance is longer than the first distance.

3. The cartridge according to claim 2,
wherein the photoconductor-drum unit includes
a collecting member provided in contact with the cleaning member and configured to collect paper lint from foreign matter collected from the photoconductor drum by the cleaning member; and
a collecting electrode provided at the end face and electrically connected to the collecting member, and
wherein defining a distance between the wire electrode and the collecting electrode when viewed in the direction of the first rotation axis as a third distance,
the third distance is longer than the first distance.

4. The cartridge according to claim 1,
wherein the cleaning member is a cleaning roller provided in contact with the surface of the photoconductor drum, and
wherein when viewed in the direction of the first rotation axis, a rotation axis of the cleaning roller is located on the same side as the wire electrode with respect to the virtual straight line.

5. The cartridge according to claim 4,
wherein when viewed in the direction of the first rotation axis, a distance from the charging wire to the wire electrode is shorter than a distance from a rotation axis of the cleaning roller to the cleaning electrode.

6. The cartridge according to claim 4,
wherein the photoconductor-drum unit includes
a cover member forming at least part of the end face of the photoconductor-drum unit; and
an electrically conductive part electrically connecting the cleaning electrode and the cleaning roller to each other, at least part of the cover member being made of an insulator, and
wherein the electrically conductive part is located on an inner side relative to the cover member in the direction of the first rotation axis and intersects the virtual straight line when viewed in the direction of the first rotation axis.

7. The cartridge according to claim 6,
wherein the cleaning roller is movable toward and away from the photoconductor drum, and
wherein the electrically conductive part is a pressing spring that presses the cleaning roller against the photoconductor drum.

8. The cartridge according to claim 1,
wherein the photoconductor-drum unit includes
a grid provided between the wire electrode and the photoconductor drum; and
a grid electrode provided at the end face and electrically connected to the grid.

9. The cartridge according to claim 1,
wherein the photoconductor-drum unit includes a static eliminating unit configured to eliminate static electricity from the surface of the photoconductor drum.
